(19) United States
(12) Patent Application Publication
(10) Pub. No.: US 2008/0183541 A1
(43) Pub. Date: Jul. 31, 2008

(54) Method of transmitting portions of media

(76) Inventors: Albert Wenger, Scarsdale, NY (US); Susan Danziger, Scarsdale, NY (US)

Correspondence Address: LOWRIE, LANDO & ANASTASI, LLP, ONE MAIN STREET, SUITE 1100, CAMBRIDGE, MA, 02142, US

(21) Appl. No.: 11/698,777

(22) Filed: Jan. 26, 2007

(51) Int. Cl. G06Q 30/00

(52) U.S. Cl. 705/8

(57) ABSTRACT

System and method for providing portions of a media to a recipient according a schedule. Recipient may submit a schedule identifying times and/or days and a desired media. Portions of the identified media may be transmitted to the recipient at the scheduled times and/or days. The transmission may include an email message or other message to the recipient. Advertisements may be inserted into the portions of the media. The advertisements may be targeted at the recipient of the portions of the media and inserted according to an advertising plan of a distributor of the media. Transmission may be part of a registration-less system.

### BACKGROUND

1. Field of Invention

The present invention relates to distribution of electronic media, and the present invention particularly relates to transmitting portions of an electronic media to a recipient according to a schedule.

2. Discussion of Related Art

In a traditional broadcast medium, such as radio and television, advertisements are interspersed within media, such as music and video. Radio stations and televisions stations may collect information regarding typical listeners or viewers and target the interspersed advertisements at the typical listeners or viewers based on this collected information. Advertisers may pay broadcasters for insertion of their own advertisements into the broadcast media and may pay a premium price for targeted insertions of advertisements. In addition to the broadcast medium, advertisers also pay for and target advertisements in the less traditional medium of the Internet. For example, a website may generate advertisements whenever a user visits the website. To improve the effectiveness of these advertisements, they may be directed at visitors of the website based on known information of these users and advertiser's own marketing plans.

Media, such as books, videos, and music, traditionally have also been embodied on a physical medium, such as a hard cover book, a digital versatile disc, and a compact disc, when distributed to consumers. The physical medium is traditionally then sold through a media merchant to the consumers. In more recent years, media has been separated from these traditional physical embodiments as well as the traditional broadcast embodiments and instead sold to consumers as purely electronic data.

Online stores may sell this electronic data via the Internet to the consumers. The online stores may first receive payment from the consumers and then transfer the electronic data to the consumers. The electronic data may be transferred in a variety of formats usable by specific computer software. For example, music files may be sold and transferred in an MP3 format, books may be transferred in a PDF and/or HTML format, and videos may be transferred in a MPEG or AVI format. The electronic data may be transferred through a variety of different transfer methods, including streaming transfers in which the media is played/displayed as it is transferred (e.g., Real Audio files), and static transfers in which the media is fully transferred and saved in a local file for later use (e.g., email, FTP transfers).

### SUMMARY OF INVENTION

In one aspect of the present invention, it is realized that many media consumers may want to view and/or listen to media in portions over a period of time. For example, a book may comprise hundreds or more pages of textual information that may take an average reader an extended period, such as hours or days, to read in one sitting. So, the reader may desire to read the book in portions (e.g., chapters or pages) over a longer period of time, such as weeks or months, rather than in one extended sitting. In accordance with one aspect of the present invention, a media system may provide such readers or consumers of any type of media with portions of the media over a scheduled period rather than the entire media at one time.

In one aspect of the present invention, it is recognized that typical Internet users may take time out of their day to review their email regularly. In an otherwise busy day, such users may spend several minutes or more reviewing emails they have received. In accordance with one aspect of the present invention, a media system may transmit media to such users within an email message. In one embodiment, the email message may contain a portion of the media that typical Internet users may feel comfortable viewing/listening to during the time they take out of their day to review their email.

It is further recognized that advertisements may be inserted within portions of media, such as the portions transmitted by email from the media system. In accordance with one aspect of the present invention, a media system may transmit portions of a media having at least one advertisement inserted within the portions. Such advertisements may be target at the recipients of the media. For example, in some embodiments, the advertisements may be based on the media being transmitted, other media received by a recipient, and/or information regarding the recipient of the portions.

One aspect of the present invention includes a method of distributing at least part of a media. In one embodiment, the method comprises acts of inserting at least one advertisement into at least one of at least one first representation of at least one first portion of the media and at least one second representation of at least one second portion of the media; distributing the at least one first representation at least one first scheduled time; and distributing the at least one second representation at least one second scheduled time.

Some embodiment further comprise an act of receiving at least one representation of the at least one advertisement from at least one advertiser. In some embodiment, inserting includes an act of inserting the at least one advertisement into at least one of the at least one first representation and the at least one second representation based, at least in part, on at least one of an advertising plan of the media and a marketing plan of the at least one advertisement. Some embodiment, further comprise an act of adjusting the at least one marketing plan based, at least in part, on an input from at least one advertiser. In some embodiment the marketing plan indicating a characteristic of a target market of the at least one advertisement. Some embodiment, further comprise an act of adjusting the at least one advertising plan based, at least in part, on an input from a distributor of the media. In some embodiment the at least one distributor includes at least one of a publisher of the media and a creator of the media.

In some embodiment the at least one advertising plan includes at least one of the group comprising a plan indicating the at least one advertisement, a plan indicating a type of advertisement to include in the at least one advertisement, a plan indicating a number of advertisements to include in the at least one advertisement, a plan indicating a frequency of advertisements with which to insert the at least one advertisement, and a plan indicating at least one licensing plan.

In some embodiment inserting includes an act of inserting the at least one advertisement into at least one of the at least one first representation and the at least one second representation based, at least in part, on at least one characteristic of a recipient of at least one of the distributed at least one first representation and distributed at least one second representation. In some embodiment the at least one characteristic includes an identity of at least one previously received media. In some embodiment the at least one characteristic includes demographic information received from the recipient. In some embodiment the demographic information includes at least one of the group comprising: an age, a gender, a name, an ethnicity, an education, a profession, an income, and a location.

Some embodiment further comprise an act of receiving at least one indication of the at least one characteristic of the recipient. In some embodiment the at least one first representation includes at least one preview portion into which the at least one advertisement is not inserted, and wherein the at least one second representation includes at least one subscription portion into which the at least one advertisement is inserted. In some embodiment distributing includes at least one of the group comprising transmitting at least one email message, transmitting at least one MMS message, and distributing at least one RSS feed. In some embodiment the media includes an electronic file comprising at least one of audio, video, image, and textual information. In some embodiment the media includes an electronic book. Some embodiment further comprise an act of dividing at least one representation of the media into the at least one first portion and the at least one second portion.

Some embodiment further comprise an act of dividing the at least one representation of the media into the at least one first portion and the at least one second portion based on at least one criterion. In some embodiment the at least one criterion includes at least one of the group comprising: a page break, a length of time, a size of the at least one first representation, a size of the at least one second representation, a chapter break, a scene change, a track break, a character count, a line count, a byte count, a paragraph count, a word count, and a piece of metadata indicating a portion break. In some embodiment the at least one criterion includes at least one criterion of at least one advertising plan of at least one of a distributor of the media and an advertiser associated with the at least one advertisement. In some embodiment the at least one criterion includes at least one criterion selected by a recipient of the at least one first representation and the at least one second representation.

Some embodiment further comprise an act of receiving at least one indication of a selection of the at least one criterion from the recipient. Some embodiment, further comprise an act of receiving at least one representation of a schedule, wherein the at least one representation of the schedule includes an indication of the at least one first scheduled time and the at least one second scheduled time. In some embodiment the at least one representation of the schedule further includes an indication of the media. In some embodiment the at least one representation of the schedule further includes an indication of at least one intended recipient of at least one of the at least one first representation and the at least one second representation. In some embodiment the at least one intended recipient includes a group of recipients. In some embodiment the at least one intended recipient submits the at least one representation of the at least one schedule through at least one user interface. In some embodiment the at least one user interface includes at least one website and the at least one representation of the schedule includes at least one HTTP message.

Some embodiment further comprise an act of responding to a request from the recipient of at least one of the at least one first representation and the at least one second representation by distributing at least one third representation of at least one third portion of the media, and wherein inserting includes an act of inserting the at least one advertisement into the at least one third representation. In some embodiment the at least one third portion of the media includes at least one of the at least one first portion of the media and the at least one second portion of the media.

One aspect of the present invention includes a method of emailing at least a first portion of a media. In some embodiments, the method comprises acts of inserting at least one advertisement into at least one first representation of at least the first portion of the media; and transmitting at least one first email containing the at least one first representation of at least the first portion of the media.

Some embodiment further comprise an act of receiving at least one representation of the at least one advertisement from at least one advertiser. In some embodiment inserting includes an act of inserting the at least one advertisement into the at least one first representation based, at least in part, on at least one of an advertising plan of the media and a marketing plan of the at least one advertisement. Some embodiment further comprise an act of adjusting the at least one marketing plan based, at least in part, on an input from at least one advertiser. In some embodiment the marketing plan indicating a characteristic of a target market of the at least one advertisement. Some embodiment further comprise an act of adjusting the at least one advertising plan based, at least in part, on an input from at a distributor of the media.

In some embodiment the at least one distributor includes at least one of a publisher of the media and a creator of the media. In some embodiment the at least one advertising plan includes at least one of the group comprising: a plan indicating the at least one advertisement, a plan indicating a type of advertisement to include in the at least one advertisement, a plan indicating a number of advertisements to include in the at least one advertisement, a plan indicating a frequency of advertisements with which to insert the at least one advertisement, and a plan indicating at least one licensing plan.

In some embodiment inserting includes an act of inserting the at least one advertisement into the at least one first representation of the at least one first portion of the media based, at least in part, on at least one characteristic of a recipient of the at least one first email. In some embodiment the at least one characteristic includes an identity of at least one previously received media. In some embodiment the at least one characteristic includes demographic information received from the recipient. In some embodiment the demographic information includes at least one of the group comprising: an age, a gender, a name, an ethnicity, an education, a profession, an income, and a location.

Some embodiment further comprise an act of receiving at least one indication of the at least one characteristic of the recipient. In some embodiment the media includes an electronic file comprising at least one of audio, video, image, and textual information. In some embodiment the media includes an electronic book. Some embodiment further comprise an act of transmitting at least one second email containing at least one second representation of at least one second portion of the media. In some embodiment inserting further includes an act of inserting the at least one advertisement into the at least one second representation. Some embodiment further comprise an act of dividing at least one representation of the media into at least the at least one first portion and the at least one second portion. In some embodiment dividing includes an act of dividing at least one representation of the media into at least the at least one first portion and the at least one second portion based on at least one criterion. In some embodiment the at least one criterion includes at least one of the group comprising: a page break, a length of time, a size of the at least one first representation, a size of the at least one second representation, a chapter break, a scene change, a track break, a character count, a line count, a byte count, a paragraph count, a word count, and a piece of metadata indicating a portion break.

In some embodiment the at least one criterion includes at least one criterion of a distributor of the media. In some embodiment the at least one criterion includes at least one criterion of a recipient of at least one of the at least one first email and the at least one second email. Some embodiment further comprise an act of receiving at least one indication of the at least one criterion. In some embodiment transmitting the first representation occurs at a first scheduled time and transmitting the second representation occurs at a second scheduled time. Some embodiment further comprise an act of receiving at least one representation of a schedule, wherein the at least one representation of the schedule includes an indication of the at least one first scheduled time and the at least one second scheduled time. In some embodiment the at least one representation of the schedule further includes an indication of the media.

In some embodiment the at least one representation of the schedule further includes an indication of at least one intended recipient of at least one of the at least one first email and the at least one second email. In some embodiment the at least one intended recipient includes a group of recipients. In some embodiment the at least one intended recipient submits the at least one representation of the schedule through at least one user interface. In some embodiment the at least one user interface includes at least one website and the at least one representation of the at least one schedule includes at least one HTTP message.

Some embodiment further comprise an act of responding to a request from the recipient of at least one of the at least one first email and the at least one second email by transmitting at least one third representation of at least one third portion of the media, and wherein inserting includes an act of inserting the at least one advertisement into the at least one third representation of the at least one third portion. In some embodiment the third portion includes at least one of the first portion and the second portion.

One aspect of the present invention includes a method of emailing a media. In some embodiments, the method comprises acts of transmitting at least one first email containing at least one first representation of at least one first portion of the media at at least one first scheduled time; and transmitting at least one second email containing at least one second representation of at least one second portion of the media at least one second scheduled time, wherein the at least one first portion of the media and the at least one second portion of the media represent the media.

Some embodiment further comprise an act of inserting at least one advertisement into at least one of the at least one first representation and the at least one second representation. Some embodiment further comprise an act of receiving at least one representation of the at least one advertisement from at least one advertiser. In some embodiment inserting includes an act of inserting at least one advertisement into at least one of the at least one first representation and the at least one second representation based, at least in part, on at least one of an advertising plan of the media and a marketing plan of the at least one advertisement.

Some embodiment further comprise an act of adjusting the at least one marketing plan based, at least in part, on an input from at least one advertiser. In some embodiment the marketing plan indicating a characteristic of a target market of the at least one advertisement. Some embodiment further comprise an act of adjusting the at least one advertising plan based, at least in part, on an input from a distributor of the media. In some embodiment the at least one distributor includes at least one of a publisher of the media and a creator of the media. In some embodiment the at least one advertising plan includes at least one of the group comprising: a plan indicating the at least one advertisement, a plan indicating a type of advertisement to include in the at least one advertisement, a plan indicating a number of advertisements to include in the at least one advertisement, a plan indicating a frequency of advertisements with which to insert the at least one advertisement, and a plan indicating at least one licensing plan.

In some embodiment inserting includes an act of inserting the at least one advertisement into at least one of the at least one first representation and at least one second representation based, at least in part, on at least one characteristic of a recipient of at least one of the at least one first email and the at least one second email. In some embodiment the at least one characteristic includes an identity of at least one previously received media. In some embodiment the at least one characteristic includes demographic information received from the recipient. In some embodiment the demographic information includes at least one of the group comprising: an age, a gender, a name, an ethnicity, an education, a profession, an income, and a location. Some embodiment further comprise an act of receiving at least one indication of the at least one characteristic of the recipient. In some embodiment the at least one first representation includes at least one preview portion into which the at least one advertisement is not inserted, and wherein the at least one second representation of the at least one second portion includes at least one representation of at least one subscription portion into which the at least one advertisement is inserted.

In some embodiment the media includes an electronic file comprising at least one of audio, video, image, and textual information. In some embodiment the media includes an electronic book. Some embodiment further comprise an act of dividing at least one representation of the media into the at least one first portion of the at least one second portion. In some embodiment dividing includes an act of dividing the at least one representation of the media into the at least one first portion of the at least one second portion based on at least one criterion. In some embodiment the at least one criterion includes at least one of the group comprising: a page break, a length of time, a size of the at least one first representation, a size of the at least one second representation, a chapter break, a scene change, a track break, a character count, a line count, a byte count, a paragraph count, a word count, and a piece of metadata indicating a portion break.

In some embodiment the at least one criterion includes at least one criterion of an advertising plan of a distributor of the media. In some embodiment the at least one criterion includes at least one criterion selected by a recipient of at least one of the at least one first email and the at least one second email. Some embodiment further comprise an act of receiving at least one indication of a selection of the at least one criterion from the recipient. Some embodiment further comprise an act of receiving at least one representation of a schedule, wherein the at least one representation of the schedule includes at least one indication of the at least one first scheduled time and the at least one second scheduled time. In some embodiment the at least one representation of the schedule further includes an indication of the media. In some embodiment the at least one representation of the schedule further includes at least one indication of at least one intended recipient of at least one of the at least one first email and the at least one second email. In some embodiment the at least one intended recipient includes a group of recipients.

In some embodiment the at least one intended recipient submits the at least one representation of the schedule through at least one user interface. In some embodiment the at least one user interface includes at least one website and the at least one representation of the schedule includes at least one HTTP message.

One aspect of the present invention includes a system for distributing at least part of a media. In some embodiments, the system comprises an advertising element configured to insert at least one advertisement into at least one of at least one first representation of at least one first portion of the media and at least one second representation of at least one second portion of the media; and a schedule element configured to distribute the at least one first representation at least one first scheduled time; and configured to distribute the at least one second representation at at least one second scheduled time.

In some embodiment the advertising element is further configured to receive at least one representation of the at least one advertisement from at least one advertiser. In some embodiment the advertising element is configured to insert the at least one advertisement into at least one of the at least one first representation and the at least one second representation based, at least in part, on at least one of an advertising plan of the media and a marketing plan of the at least one advertisement. In some embodiment the advertising element is further configured to adjust the at least one marketing plan based, at least in part, on an input from at least one advertiser. In some embodiment the marketing plan indicating a characteristic of a target market of the at least one advertisement.

In some embodiment the system further comprises a media element configured to adjust the at least one advertising plan based, at least in part, on an input from at least one of a distributor of the media. In some embodiment the at least one distributor includes at least one of a publisher of the media and a creator of the media. In some embodiment the at least one advertising plan includes at least one of the group comprising a plan indicating the at least one advertisement, a plan indicating a type of advertisement to include in the at least one advertisement, a plan indicating a number of advertisements to include in the at least one advertisement, a plan indicating a frequency of advertisements with which to insert the at least one advertisement, and a plan indicating at least one licensing plan.

In some embodiment the advertising element is configured to insert the at least one advertisement into at least one of the at least one first representation and the at least one second representation based, at least in part, on at least one characteristic of a recipient of at least one of the distributed at least one first representation and distributed at least one second representation. In some embodiment the at least one characteristic includes an identity of at least one previously received media. In some embodiment the at least one characteristic includes demographic information received from the recipient. In some embodiment the demographic information includes at least one of the group comprising an age, a gender, a name, an ethnicity, an education, a profession, an income, and a location.

In some embodiment the advertising element is further configured to receive at least one indication of the at least one characteristic of the recipient. In some embodiment the at least one first representation includes at least one preview portion into which the advertising element is configured not to insert the at least one advertisement, and wherein the at least one second representation includes at least one subscription portion into which the advertising element is configured to insert the at least one advertisement. In some embodiment at least one of the first and second representations includes at least one of an email message, an RSS feed, and an MMS message. In some embodiment the media includes an electronic file comprising at least one of audio, video, image, and textual information. In some embodiment the media includes an electronic book.

Some embodiments further comprise a media element configured to divide at least one representation of the media into the at least one first portion and the second portion. In some embodiment the media element is configured to divide the at least one representation of the media into the at least one first portion and the at least one second portion based on at least one criterion. In some embodiment the at least one criterion includes at least one of the group comprising: a page break, a length of time, a size of the at least one first representation, a size of the at least one second representation, a chapter break, a scene change, a track break, a character count, a line count, a byte count, a paragraph count, a word count, and a piece of metadata indicating a portion break.

In some embodiment the at least one criterion includes at least one criterion of an advertising plan of at least one of a distributor of the media. In some embodiment the at least one criterion includes at least one criterion selected by a recipient of at least one of the distributed at least one first representation and the distributed at least one second representation. In some embodiment the media element is further comprising to receive at least one indication of a selection of the at least one criterion from the recipient. In some embodiment the schedule element is further configured to receive at least one representation of a schedule, wherein the at least one representation of the schedule includes an indication of the at least one first scheduled time and the at least one second scheduled time.

In some embodiment the at least one representation of the schedule further includes an indication of the media. In some embodiment the at least one representation of the schedule further includes an indication of at least one intended recipient of at least one of the at least one first representation and the at least one second representation. In some embodiment the at least one intended recipient includes a group of recipients. In some embodiment the schedule element is further configured to respond to a request from the recipient of at least one of the at least one first representation and the at least one second representation by distributing at least one third representation of at least one third portion of the media, and wherein the advertising element is further configured to insert the at least one advertisement into the at least one third representation.

One aspect of the present invention includes system for emailing at least a first portion of a media. In some embodiments, the system comprises an advertising element configured to insert at least one advertisement into at least one first representation of at least the first portion of the media; and a transmission elements configured to transmitting at least one first email containing the at least one first representation of at least the first portion of the media.

In some embodiment the advertising element is further configured to receive at least one representation of the at least one advertisement from at least one advertiser. In some embodiment the advertising element is configured to insert the at least one advertisement into the at least one first representation based, at least in part, on at least one of an advertising plan of the media and a marketing plan of the at least one advertisement. In some embodiment the advertising element is further configured to adjust the at least one marketing plan based, at least in part, on an input from at least one advertiser.

In some embodiment the marketing plan indicating a characteristic of a target market of the at least one advertisement. In some embodiment the system further comprises a media element configured to adjust the at least one advertising plan based, at least in part, on an input from at least one of a distributor of the media. In some embodiment the at least one distributor includes at least one of a publisher of the media and a creator of the media. In some embodiment the at least one advertising plan includes at least one of the group comprising a plan indicating the at least one advertisement, a plan indicating a type of advertisement to include in the at least one advertisement, a plan indicating a number of advertisements to include in the at least one advertisement, a plan indicating a frequency of advertisements with which to insert the at least one advertisement, and a plan indicating at least one licensing plan.

In some embodiment the advertising element is configured to insert the at least one advertisement into the at least one first representation of the at least one first portion of the media based, at least in part, on at least one characteristic of a recipient of the at least one first email. In some embodiment the at least one characteristic includes an identity of at least one previously received media. In some embodiment the at least one characteristic includes demographic information received from the recipient. In some embodiment the demographic information includes at least one of the group comprising an age, a gender, a name, an ethnicity, an education, a profession, an income, and a location. In some embodiment the advertising element is further configured to receive at least one indication of the at least one characteristic of the recipient. In some embodiment the media includes an electronic file comprising at least one of audio, video, image, and textual information. In some embodiment the media includes an electronic book.

In some embodiment the transmission element is further configured to transmit at least one second email containing at least one second representation of at least one second portion of the media. In some embodiment the advertising element is further configured to insert the at least one advertisement into the at least one second representation. Some embodiments further comprise a media element configured to divide at least one representation of the media into at least the at least one first portion and the at least one second portion. In some embodiment the media element is configured to divide the at least one representation of the media into at least the at least one first portion and the at least one second portion based on at least one criterion. In some embodiment the at least one criterion includes at least one of the group comprising a page break, a length of time, a size of the at least one first representation, a size of the at least one second representation, a chapter break, a scene change, a track break, a character count, a line count, a byte count, a paragraph count, a word count, and a piece of metadata indicating a portion break.

In some embodiment the at least one criterion includes at least one criterion of a distributor of the media. In some embodiment the at least one criterion includes at least one criterion of a recipient of at least one of the at least one first email and the at least one second email. In some embodiment the media element is further configured to receive at least one indication of the at least one criterion. In some embodiment the transmission element is configured to transmit the at least one first email at a first scheduled time and to transmit the second email at a second scheduled time. In some embodiment the transmission element is further configured to receive at least one representation of a schedule, wherein the at least one representation of the schedule includes an indication of the at least one first scheduled time and the at least one second scheduled time. In some embodiment the at least one representation of the schedule further includes an indication of the media.

In some embodiment the at least one representation of the schedule further includes an indication of at least one intended recipient of at least one of the at least one first email and the at least one second email. In some embodiment the at least one intended recipient includes a group of recipients. In some embodiment the transmission element is further configured to respond to a request from the recipient of at least one of the at least one first email and the at least one second email by transmitting at least one third representation of at least one third portion of the media, and wherein the advertising element is further configured to insert the at least one advertisement into the at least one third representation of the at least one third portion.

One aspect of the present invention includes a system for emailing a media. In some embodiments, the system comprises a schedule element configured to transmit at least one first email containing at least one first representation of at least one first portion of the media at least one first scheduled time, and configured to transmit at least one second email containing at least one second representation of at least one second portion of the media at least one second scheduled time, wherein the at least one first portion of the media and the at least one second portion of the media represent the media.

Some embodiments further comprise an advertising element configured to insert at least one advertisement into at least one of the at least one first representation and the at least one second representation. In some embodiment the advertising element is further configured to receive at least one representation of the at least one advertisement from at least one advertiser. In some embodiment the advertising element is configured to insert the at least one advertisement into at least one of the at least one first representation and the at least one second representation based, at least in part, on at least one of an advertising plan of the media and a marketing plan of the at least one advertisement. In some embodiment the advertising element is further configured to adjust the at least one marketing plan based, at least in part, on an input from at least one advertiser. In some embodiment the marketing plan indicating a characteristic of a target market of the at least one advertisement.

In some embodiment the system further comprises a media element configured to adjust the at least one advertising plan based, at least in part, on an input from at least one of a distributor of the media. In some embodiment the at least one distributor includes at least one of a publisher of the media and a creator of the media. In some embodiment the at least one advertising plan includes at least one of the group comprising a plan indicating the at least one advertisement, a plan indicating a type of advertisement to include in the at least one advertisement, a plan indicating a number of advertisements to include in the at least one advertisement, a plan indicating a frequency of advertisements with which to insert the at least one advertisement, and a plan indicating at least one licensing plan. In some embodiment the advertising element is configured to insert the at least one advertisement into at least one of the at least one first representation and at least one second representation based, at least in part, on at least one characteristic of a recipient of at least one of the at least one first email and the at least one second email.

In some embodiment the at least one characteristic includes an identity of at least one previously received media. In some embodiment the at least one characteristic includes demographic information received from the recipient. In some embodiment the demographic information includes at least one of the group comprising an age, a gender, a name, an ethnicity, an education, a profession, an income, and a location. In some embodiment the advertising element is further configured to receive at least one indication of the at least one characteristic of the recipient. In some embodiment the at least one first representation includes at least one preview portion into which the advertisement element is configured not to insert the at least one advertisement, and wherein the at least one second representation of the at least one second portion includes at least one representation of at least one subscription portion into which the advertisement element is configured to insert the least one advertisement.

In some embodiment the media includes an electronic file comprising at least one of audio, video, image, and textual information. In some embodiment the media includes an electronic book. Some embodiments further comprise a media element configured to divide at least one representation of the media into the at least one first portion and at least one second portion. In some embodiment the media element is configured to divide the at least one representation of the media into the at least one first portion and the at least one second portion based on at least one criterion. In some embodiment the at least one criterion includes at least one of the group comprising: a page break, a length of time, a size of the at least one first representation, a size of the at least one second representation, a chapter break, a scene change, a track break, a character count, a line count, a byte count, a paragraph count, a word count, and a piece of metadata indicating a portion break.

In some embodiment the at least one criterion includes at least one criterion of an advertising plan of a distributor of the media. In some embodiment the at least one criterion includes at least one criterion selected by a recipient of at least one of the at least one first email and the at least one second email. In some embodiment the media element is further configured to receive at least one indication of a selection of the at least one criterion from the recipient. In some embodiment the schedule element is further configured to receive at least one representation of a schedule, wherein the at least one representation of the schedule includes at least one indication of the at least one first scheduled time and the at least one second scheduled time. In some embodiment the at least one representation of the schedule further includes an indication of the media. In some embodiment the at least one representation of the schedule further includes at least one indication of at least one intended recipient of at least one of the at least one first email and the at least one second email. In some embodiment the at least one intended recipient includes a group of recipients.

One aspect of the present invention includes a method of distributing at least part of a media. In some embodiments, the method comprises acts of distributing at least one first representation of a preview portion of the media to at least one recipient at least one first scheduled time receiving a media subscription fee from the at least one recipient; and after receiving the media subscription fee, distributing at least one second representation of a subscription portion of the media at least one second scheduled time.

Some embodiments further comprise inserting at least one advertisement into at least one of the at least one first representation and the at least one second representation. Some embodiments further comprise receiving at least one representation of the at least one advertisement from at least one advertiser. In some embodiment inserting includes an act of inserting the at least one advertisement into at least one of the at least one first representation and the at least one second representation based, at least in part, on at least one of an advertising plan of the media and a marketing plan of the at least one advertisement.

In some embodiment the at least one advertising plan includes at least one of the group comprising: a plan indicating the at least one advertisement, a plan indicating a type of advertisement to include in the at least one advertisement, a plan indicating a number of advertisements to include in the at least one advertisement, a plan indicating a frequency of advertisements with which to insert the at least one advertisement, and a plan indicating at least one licensing plan. In some embodiment the media includes an electronic file comprising at least one of audio, video, image, and textual information. In some embodiment the media includes an electronic book. Some embodiments further comprise dividing at least one representation of the media into the at least one first portion and the at least one second portion.

In some embodiment dividing includes an act of dividing the at least one representation of the media into the at least one first portion and the at least one second portion based on at least one criterion. In some embodiment the at least one criterion includes at least one of the group comprising a page break, a length of time, a size of the at least one first representation, a size of the at least one second representation, a chapter break, a scene change, a track break, a character count, a line count, a byte count, a paragraph count, a word count, and a piece of metadata indicating a portion break. In some embodiment the at least one criterion includes at least one criterion of an advertising plan of a distributor of the media. In some embodiment the at least one criterion includes at least one criterion selected by a recipient of at least one of the at least one first email and the at least one second email. Some embodiments further comprise receiving at least one indication of a selection of the at least one criterion from the recipient. Some embodiments further comprise receiving at least one representation of a schedule, wherein the at least one representation of the schedule includes at least one indication of the at least one first scheduled time and the at least one second scheduled time. In some embodiment the at least one representation of the schedule further includes an indication of the media.

In some embodiment the at least one representation of the schedule further includes at least one indication of at least one intended recipient of at least one of the at least one first email and the at least one second email. In some embodiment the at least one intended recipient includes a group of recipients. In some embodiment the at least one intended recipient submits the at least one representation of the schedule through at least one user interface. In some embodiment the at least one user interface includes at least one website and the at least one representation of the schedule includes at least one HTTP message.

One aspect of the present invention includes a system for distributing at least part of a media. In some embodiments, the system comprises a subscription element configured to receive a media subscription fee from at least one recipient; and a schedule element configured to distribute at least one representation of a preview portion of the media to at least one recipient at least one first scheduled time, and configured to distribute at least one representation of a subscription portion of the media at least one second scheduled time only after the subscription element receives the media subscription fee.

Some embodiments further comprise an advertising element configured to insert at least one advertisement into at least one of the at least one first representation and the at least one second representation. In some embodiment the advertising element is further configured to receive at least one representation of the at least one advertisement from at least one advertiser. In some embodiment the advertising element is configured to insert the at least one advertisement into at least one of the at least one first representation and the at least one second representation based, at least in part, on at least one of an advertising plan of the media and a marketing plan of the at least one advertisement.

In some embodiment the at least one advertising plan includes at least one of the group comprising a plan indicating the at least one advertisement, a plan indicating a type of advertisement to include in the at least one advertisement, a plan indicating a number of advertisements to include in the at least one advertisement, a plan indicating a frequency of advertisements with which to insert the at least one advertisement, and a plan indicating at least one licensing plan. In some embodiment the media includes an electronic file comprising at least one of audio, video, image, and textual information. In some embodiment the media includes an electronic book. Some embodiments further comprise a media element configured to divide at least one representation of the media into the at least one first portion and the at least one second portion. In some embodiment the media element is configured to divide at least one representation of the media into the at least one first portion and the at least one second portion based on at least one criterion.

In some embodiment the at least one criterion includes at least one of the group comprising a page break, a length of time, a size of the at least one first representation, a size of the at least one second representation, a chapter break, a scene change, a track break, a character count, a line count, a byte count, a paragraph count, a word count, and a piece of metadata indicating a portion break. In some embodiment the at least one criterion includes at least one criterion of an advertising plan of a distributor of the media. In some embodiment the at least one criterion includes at least one criterion selected by a recipient of at least one of the at least one first email and the at least one second email. In some embodiment the media element is further configured to receive at least one indication of a selection of the at least one criterion from the recipient. In some embodiment the schedule element is further configured to receive at least one representation of a schedule, wherein the at least one representation of the schedule includes at least one indication of the at least one first scheduled time and the at least one second scheduled time.

In some embodiment the at least one representation of the schedule further includes an indication of the media. In some embodiment the at least one representation of the schedule further includes at least one indication of at least one intended recipient of at least one of the at least one first email and the at least one second email. In some embodiment the at least one intended recipient includes a group of recipients. In some embodiment the at least one intended recipient submits the at least one representation of the schedule through at least one user interface. In some embodiment the at least one user interface includes at least one website and the at least one representation of the schedule includes at least one HTTP message.

One aspect of the present invention includes a method of distributing at least part of a media. In some embodiments, the method comprises acts of receiving an indication of an email address from a user; receiving an indication of the media from the user; receiving an indication of a schedule from the user; and without requiring the user to provide registration information, transmitting at least one first email representing at least a first portion of the media to the user at a time and day based, at least in part, on the schedule.

Some embodiments further comprise transmitting at least one second email representing at least a second portion of the media at a time and day based, at least in part, on the schedule, wherein the at least the first portion and the at least the second portion represent the media. Some embodiments further comprise inserting at least one advertisement into the at least one first email before transmitting the at least one first email to the user. Some embodiments further comprise receiving at least one representation of the at least one advertisement from at least one advertiser. In some embodiments inserting includes an act of inserting the at least one advertisement into the at least one first email based, at least in part, on at least one of an advertising plan of the media and a marketing plan of the at least one advertisement. Some embodiments further comprise adjusting the at least one marketing plan based, at least in part, on an input from at least one advertiser.

In some embodiment the marketing plan indicating a characteristic of a target market of the at least one advertisement. Some embodiments further comprise adjusting the at least one advertising plan based, at least in part, on an input from a distributor of the media. In some embodiment the at least one distributor includes at least one of a publisher of the media and a creator of the media. In some embodiment the at least one advertising plan includes at least one of the group comprising: a plan indicating the at least one advertisement, a plan indicating a type of advertisement to include in the at least one advertisement, a plan indicating a number of advertisements to include in the at least one advertisement, a plan indicating a frequency of advertisements with which to insert the at least one advertisement, and a plan indicating at least one licensing plan. In some embodiment inserting includes an act of inserting the at least one advertisement based, at least in part, on at least one characteristic of the user.

In some embodiment the at least one characteristic includes an identity of at least one previously received media. In some embodiment the at least one characteristic includes demographic information received from the user. In some embodiment the demographic information includes at least one of the group comprising an age, a gender, a name, an ethnicity, an education, a profession, an income, and a location. Some embodiments further comprise receiving at least one indication of the at least one characteristic of the user. In some embodiment the media includes an electronic file comprising at least one of audio, video, image, and textual information. In some embodiment the media includes an electronic book.

Some embodiments further comprise dividing at least one representation of the media into the at least one first portion of the media. In some embodiments dividing includes an act of dividing the at least one representation of the media based on at least one criterion. Some embodiments further comprise receiving at least one indication of the at least one criterion from the recipient. In some embodiment the first email includes at least one hyperlink to at least one management interface. In some embodiment the at least one management interface includes at least one website through which the user may manage transmission of the media. Some embodiments further comprise receiving at least one request to adjust the schedule from the user; and adjusting the schedule based, at least in part, on the at least one request.

Some embodiments further comprise receiving at least one request to review at least one previously transmitted portion of the media from the user. Some embodiments further comprise transmitting a second email representing the at least one previously transmitted portion of the media to the user. Some embodiments further comprise displaying the at least one previously transmitted portion of the media to the user through the management interface. Some embodiments further comprise providing the user with a subscription management interface. In some embodiment the user may manage the schedule and a plurality of other schedules associated with the user through the subscription management interface.

One aspect includes a method of distributing portions of media. In some embodiments, the method comprises acts of distributing a first plurality of portions of a first version of the media to a first user according to a first schedule; and distributing a second plurality of portions of a second version of the media to a second user according to a second schedule.

In some embodiment distributing the first plurality of portions includes transmitting a plurality of first emails to the first user, and distributing the second plurality of portions includes transmitting a plurality of second emails to the second user. In some embodiment the first version of the media includes a first set of portion breaks, and the second version of the media includes a second set of portion breaks, each portion break corresponding to an end of a respective portion. In some embodiment the first set of portion breaks are determined based on at least one of a first page break, a first length of time, a first portion size, a first chapter break, a first scene change, a first track break, a first character count, a first line count, a first byte count, a first word count, a first paragraph count, and a first piece of metadata, and the second set of portion breaks are determined based on at least one of a second page break, a second length of time, a second portion size, a second chapter break, a second scene change, a second track break, a second character count, a second line count, a second byte count, a second word count, a second paragraph count, and a second piece of metadata.

Some embodiments further comprise dividing the media into the first plurality of portions based, at least in part on a first criterion, and dividing the media into the second plurality of portions based, at least in part, on a second criterion. Some embodiments further comprise receiving a representation of the first criterion from at least one of the first user and a distributor of the media; and receiving a representation of the second criterion from at least one of the second user and the distributor of the media. In some embodiment the first version of the media includes a first set of content and the second version of the media includes a second set of content. Some embodiments further comprise receiving a representation of a selection of the first version from the first user; and receiving a representation of a selection of the second version from the second user. Some embodiments further comprise receiving the first and second version of the media from a distributor of the media. Some embodiments further comprise receiving a representation of a first subscription to the media from the first user; and receiving a representation of a second subscription to the media from the second user. In some embodiment the first subscription includes the first schedule and the second subscription includes the second schedule.

Some embodiments further comprise assigning the first version of the media to the first user based, at least in part, on a first time at which the representation of the first schedule is received, and the assigning the second version of the media to the second user based at least in part on a second time at which the representation of the second schedule is received. Some embodiments further comprise receiving a representation of the second version of the media. In some embodiments the first time is before the representation is received and the second time is after the representation is received. In some embodiment the representation of the second version of the media is received from a distributor of the media. In some embodiment the media includes an electronic file comprising at least one of audio, video, image, and textual information. In some embodiment the media includes an electronic book. Some embodiments further comprise inserting at least one first advertisement into the first plurality of portions; and inserting at least one second advertisement into the second plurality of portions.

One aspect includes a system for distributing at least part of a media. In some embodiments, the system comprises a subscription element configured to receive an indication of an email address from a user, receive an indication of the media from the user, and receive an indication of a schedule from the user; and a schedule element configured to transmit at least one first email representing at least a first portion of the media to the user at a time and day based, at least in part, on the schedule without requiring the user to provide registration information.

In some embodiment the schedule element is configured to transmit at least one second email representing at least a second portion of the media at a time and day based, at least in part, on the schedule, wherein the at least the first portion and the at least the second portion represent the media. Some embodiments further comprise an advertising element configured to insert at least one advertisement into the at least one first email before the schedule element transmits the at least one first email to the user. In some embodiment the advertising element is configured to receive at least one representation of the at least one advertisement from at least one advertiser. In some embodiment the advertising element is configured to insert the at least one advertisement into the at least one first email based, at least in part, on at least one of an advertising plan of the media and a marketing plan of the at least one advertisement.

In some embodiment the advertising element is configured to adjust the at least one marketing plan based, at least in part, on an input from at least one advertiser. In some embodiment the marketing plan indicating a characteristic of a target market of the at least one advertisement. In some embodiment the advertising element is configured to adjust the at least one advertising plan based, at least in part, on an input from a distributor of the media. In some embodiment the at least one distributor includes at least one of a publisher of the media and a creator of the media. In some embodiment the at least one advertising plan includes at least one of the group comprising: a plan indicating the at least one advertisement, a plan indicating a type of advertisement to include in the at least one advertisement, a plan indicating a number of advertisements to include in the at least one advertisement, a plan indicating a frequency of advertisements with which to insert the at least one advertisement, and a plan indicating at least one licensing plan.

In some embodiment the advertising element is configured to insert the at least one advertisement based, at least in part, on at least one characteristic of the user. In some embodiment the at least one characteristic includes an identity of at least one previously received media. In some embodiment the at least one characteristic includes demographic information received from the user. In some embodiment the demographic information includes at least one of the group comprising an age, a gender, a name, an ethnicity, an education, a profession, an income, and a location. In some embodiment the advertising element is configured to receive at least one indication of the at least one characteristic. In some embodiment the media includes an electronic file comprising at least one of audio, video, image, and textual information. In some embodiment the media includes an electronic book.

Some embodiments further comprise a media element configured to divide at least one representation of the media into the at least one first portion of the media. In some embodiment the media element is configured to divide the at least one representation of the media based on at least one criterion. In some embodiment the media element is configured to receive at least one indication of the at least one criterion from the user. In some embodiment the first email includes at least one hyperlink to at least one management interface. In some embodiment the at least one management interface includes at least one website through which the user may manage transmission of the media, and further comprising at least one management element configured to provide the management interface in response to the user clicking on the at least on hyperlink.

In some embodiment the management element is configured to receiving at least one request to adjust the schedule from the user; and the schedule element is configured to adjust the schedule based, at least in part, on the at least one request. In some embodiment the management element is configured to receive at least one request to review at least one previously transmitted portion of the media from the user. In some embodiment the management element is configured to transmit a second email representing the at least one previously transmitted portion of the media to the user. In some embodiment the management element is configured to display the at least one previously transmitted portion of the media to the user through the management interface. Some embodiments further comprise at least one management element configured to provide the user with a subscription management interface. In some embodiment the user may manage the schedule and a plurality of other schedules associated with the user through the subscription management interface.

One aspect includes a system for distributing portions of media. In some embodiments, the system comprises a schedule element configured to distribute a first plurality of portions of a first version of the media to a first user according to a first schedule, and configured to distribute a second plurality of portions of a second version of the media to a second user according to a second schedule; and a media element configured to store at least one representation of the media.

In some embodiment the schedule element is configured to transmit a plurality of first emails to the first user, and transmit a plurality of second emails to the second user. In some embodiment the first version of the media includes a first set of portion breaks, and the second version of the media includes a second set of portion breaks, each portion break corresponding to an end of a respective portion. In some embodiment the media element is configured to determined the first set of portion breaks based on at least one of a first page break, a first length of time, a first portion size, a first chapter break, a first scene change, a first track break, a first character count, a first line count, a first byte count, a first word count, a first paragraph count, and a first piece of metadata, and the to determine the second set of portion breaks based on at least one of a second page break, a second length of time, a second portion size, a second chapter break, a second scene change, a second track break, a second character count, a second line count, a second byte count, a second word count, a second paragraph count, and a second piece of metadata.

In some embodiment the media element is configured to divide the media into the first plurality of portions based, at least in part on a first criterion, and to divide the media into the second plurality of portions based, at least in part, on a second criterion. In some embodiment the media element is configured to receiving a representation of the first criterion from at least one of the first user and a distributor of the media, and to receive a representation of the second criterion from at least one of the second user and the distributor of the media. In some embodiment the first version of the media includes a first set of content and the second version of the media includes a second set of content. In some embodiment the media element is configured to receive a representation of a selection of the first version from the first user, and to receive a representation of a selection of the second version from the second user.

In some embodiment the media element is configured to receive the first and second version of the media from a distributor of the media. In some embodiment the schedule element is configured to receive a representation of a first subscription to the media from the first user, and to receive a representation of a second subscription to the media from the second user. In some embodiment the first subscription includes the first schedule and the second subscription includes the second schedule. In some embodiment the media element is configured to assign the first version of the media to the first user based, at least in part, on a first time at which the representation of the first schedule is received, and the to assign the second version of the media to the second user based at least in part on a second time at which the representation of the second schedule is received.

In some embodiment the media element is configured to receive a representation of the second version of the media. In some embodiment the first time is before the representation is received and the second time is after the representation is received. In some embodiment the media element is configured to receive the representation of the second version of the media from a distributor of the media. In some embodiment the media includes an electronic file comprising at least one of audio, video, image, and textual information. In some embodiment the media includes an electronic book. Some embodiments further comprise an advertising element configured to insert at least one first advertisement into the first plurality of portions, and to insert at least one second advertisement into the second plurality of portions.

Further features and advantages of the present invention as well as the structure and operation of various embodiments of the present invention are described in detail below with reference to the accompanying drawings. In the drawings, like reference numerals indicate like or functionally similar elements. Additionally, the left-most one or two digits of a reference numeral identifies the drawing in which the reference numeral first appears.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates a computer system architecture that may be used to perform one or more acts in accordance with some embodiments of the present invention;

FIG. 2 illustrates a distributed system that may be used to perform one or more acts in accordance with some embodiments of the present invention;

FIG. 3 illustrates a set of database tables that may be used in accordance with some embodiments of the present invention;

FIG. 4 illustrates a diagram of a process for accepting a media that may be used in accordance with some embodiments of the present invention;

FIG. 5 illustrates a diagram of a process for distributing portions of media in accordance with some embodiments of the present invention;

FIG. 6 illustrates an interface through which a distributor may submit a media to the system in accordance with some embodiment of the invention;

FIG. 7 illustrates an interface through which a distributor may manage a media in accordance with some embodiments of the invention;

FIG. 8 illustrates an interface that may be used to enter a schedule in accordance with some embodiments of the present invention;

FIG. 9 illustrates a validation message that may be used in accordance with some embodiments of the present invention;

FIG. 10 illustrates a prepared portion in the form of an email message in accordance with the present invention;

FIG. 11 illustrates a second view of the prepared portion of FIG. 10;

FIG. 12 illustrates an interface through which an advertiser may submit an advertisement to a media system in accordance with some embodiments of the invention;

FIG. 13 illustrates an interface through which an advertiser may manage an advertisement in accordance with some embodiments of the present invention;

FIG. 14 illustrates a schedule management interface that may be used in accordance with some embodiments of the present invention; and

FIG. 15 illustrates a specific schedule management interface that may be used in accordance with some embodiments of the present invention.

### DETAILED DESCRIPTION

This invention is not limited in its application to the details of construction and the arrangement of components and acts set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The present invention relates generally to providing portions of a media to a user over a period of time. By providing only portions of the media to the user, a user may be more inclined to view/listen to the media than if the user were provided with the entire media at one time. For instance, in the case of an electronic book, a user may be more apt to read the book if the book is provided in smaller portions that can be reviewed at the user's convenience than in one large portion.

In some embodiments, the portions of the media may be provided in a plurality of emails. The emails may be transmitted according to a schedule indicating at least one time and day on which to transmit the emails. By transmitting the portions in emails, a typical Internet user may be more willing to view/listen to the portions of media in a typical day while checking his or her email. The size of the portions may be configured so that the typical Internet user may be willing to view/listen to the portions while checking his or her email. In some embodiments, directed advertisements may be inserted into the portions of the media. Distributors of the media may manage the advertisements based on an advertising plan (e.g., a licensing plan of the media, an advertising plan of the media). In some implementations, a media may be paid for by the advertisements and provided to a recipient the user for free. In some implementations, a recipient may be required to pay a subscription fee to receive some or all of the portions of the media, for example, in one implementations, a user may receive first set of preview portions for free and then only receive the remainder of portions after paying a subscription fee.

In the case of an electronic book, in one example, a user may be provided with a portion of the electronic book each day at a desired time. The portion may be based on chapters of the book or some number of pages or words of the book that may be convenient for the user to read while checking his or her email each day.

When the term “media” is used herein, it should be understood to include any form of media. For example, “media” may refer to textual, musical, image, and video information. In some embodiments, “media” may refer to books, audio books, music, movies, and/or television shows. Electronic versions of books and other textual information may be referred to herein as electronic books and/or ebooks.

It should be understood that such electronic books and/or ebooks are not limited to any specific ebook format but may include any of the various ebook formats, such as plain text image files, RTF, PDF and/or HTML. Furthermore, it should be understood that embodiments of the present invention are not limited to any particular media format for media other than ebooks either, but rather media may be provided to a user in any format. For example, in various embodiments, media may be provided in HTML, PDF, MP3, AVI, MPEG, and/or any other audio, video, image, or text file format.

### General Purpose Computer System

Various aspects of the present invention may be implemented on one or more computer systems. These computer systems may include, for example, general-purpose computers such as those based on Intel PENTIUM-type or Core-type processor; Motorola PowerPC; AMD Athlon, Turion or Opteron; Sun UltraSPARC; Hewlett-Packard PA-RISC processors; or any other type of processor. The system may be located on a single computer or may be distributed among multiple computers attached by a communication network.

A general-purpose computer system according to one embodiment of the invention may be configured to perform any of the described functions, including but not limited to, storing, transmitting, editing, formatting, portioning, retrieving, and inserting information. It should be appreciated that the system may perform other functions, including other acts of managing information, sharing information, and communicating with remote systems such as banks, credit card providers, media distributors, advertisers, recipients, etc. It should be appreciated that the invention is not limited to having any particular function or set of functions.

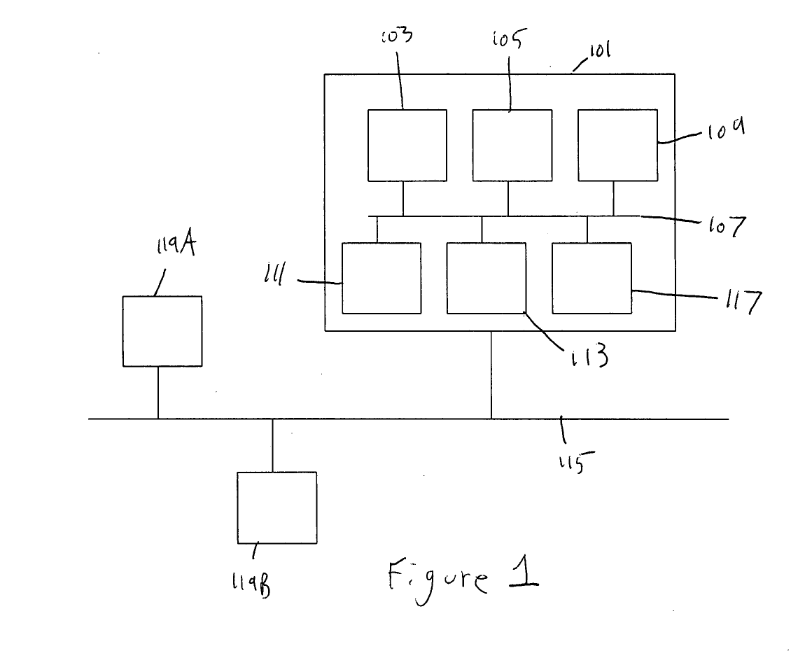

FIG. 1 illustrates a block diagram of a general purpose computer and network in which various aspects of the present invention may be practiced. For example, various aspects of the invention may be implemented as specialized software executing on one or more computer systems including general-purpose computer system 101 shown in FIG. 1. Computer system 101 may include a general-purpose computer system that is programmable using a high-level computer programming language. Computer system 101 also may be implemented using specially programmed, special purpose hardware. In computer system 101, one or more processors 103 typically include a commercially available processor such as the well-known Pentium or Core class processors available from the Intel Corporation or the well-known Athlon or Opteron class processors available from the AMD Corporation. Many other processors are available. Such a processor usually executes an operating system which may include, for example, the Windows-based operating systems (e.g., Windows NT, Windows 2000 (Windows ME), Windows XP, Windows Vista operating systems) available from the Microsoft Corporation, MAC OS System X operating system available from Apple Computer, one or more of the Linux-based operating system distributions (e.g., the Enterprise Linux operating system available from Red Hat Inc.), the Solaris operating system available from Sun Microsystems, or UNIX operating systems available from various sources. Many other operating systems may be used, and the invention is not limited to any particular operating system.

The processor and operating system together define a computer platform for which application programs in high-level programming languages are written. It should be understood that the invention is not limited to a particular computer system platform, processor, operating system, or network. Further, it should be appreciated that other appropriate programming languages and other appropriate computer systems could also be used.

Various embodiments of the present invention may be programmed using an object-oriented programming language, such as SmallTalk, Java, C++, Ada, Python, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a GUI or perform other functions). Various aspects of the invention may be implemented as programmed or non-programmed elements, or any combination thereof.

Computer system 101 may also include one or more memory devices 105, such as a disk drive, memory, or other device for storing data, connected to the processor 103. Memory 105 is typically used for storing programs and data during operation of the computer system 101. Components of computer system 101 may be coupled by an interconnection mechanism such as network 107, which may include one or more busses (e.g., between components that are integrated within a same machine) and/or a network (e.g., between components that reside on separate discrete machines). The interconnection mechanism enables communications (e.g., data, instructions) to be exchanged between system components of computer system 101.

Computer system 101 may also include one or more input/output (I/O) devices 109, for example, a keyboard, mouse, trackball, microphone, touch screen, a printing device, display screen 111, speaker, etc. In addition, computer system 101 may contain one or more interfaces (e.g., network communication device 113) that connect computer system 101 to a communication network 115 (in addition or as an alternative to the network 107).

Computer system 101 may include one or more storage systems 117. The storage system 117 typically includes a computer readable and writeable nonvolatile recording medium in which signals are stored that define a program to be executed by the processor or information stored on or in the medium to be processed by the program. The medium may, for example, be a disk or flash memory. Typically, in operation, the processor causes data to be read from the nonvolatile recording medium into another memory that allows for faster access to the information by the processor than does the non-volatile medium. This memory is typically a volatile, random access memory such as a dynamic random access memory (DRAM) or static memory (SRAM). The memory may be located in storage system 117, as shown, or in memory system 105. The processor 103 generally manipulates the data within the integrated circuit memory 103, and then copies the data to the medium associated with storage system 117 after processing is completed. A variety of mechanisms are known for managing data movement between the medium and integrated circuit memory element and the invention is not limited thereto. The invention is not limited to a particular memory system or storage system.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 101 is shown by way of example as one type of computer system upon which various aspects of the invention may be practiced, it should be appreciated that aspects of the invention are not limited to being implemented on the computer system as shown in FIG. 1. Various aspects of the invention may be practiced on one or more computers having a different architectures or components than that shown in FIG. 1.

Specifically, one or more portions of the computer system may be distributed across one or more computer systems coupled to the communications network 115 such as computer systems 119A and 119B. These computer systems also may include general-purpose computer systems. For example, various aspects of the invention may be distributed among one or more computer systems (e.g., servers) configured to provide a service to one or more client computers, or to perform an overall task or part of an overall task as part of a distributed system as described below. For example, various aspects of the invention may be performed on a client-server or multi-tier system that includes program components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

### Example Distributed System Architecture

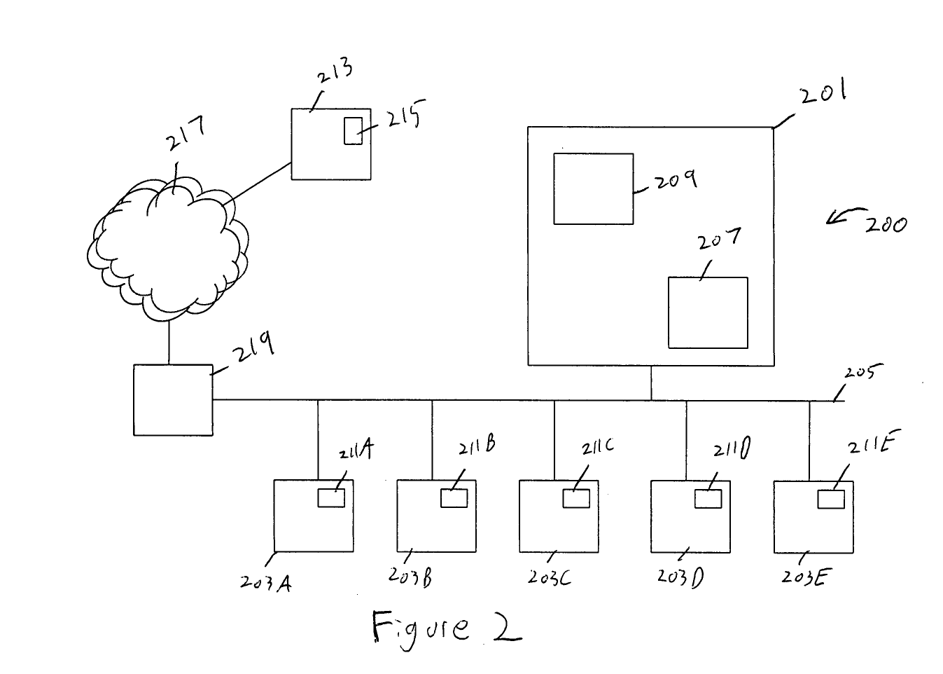

FIG. 2 illustrates an architecture diagram of an example distributed system 200 according to one embodiment of the invention on which a media system may be implemented. For example, a computer system (e.g., 201, 203A-E) may act as a web server responding to requests from users of the media system, including recipients of portions of the media, distributors of the media, advertisers, and any other users. The web server may communicate with other computer systems (e.g., 201, 203A-E), such as database servers, to obtain information that may be needed to provide responses to users and distribute portions of media according to one or more schedules. It should be appreciated that FIG. 2 is used for illustration purposes only, and that other architectures may be used to facilitate one or more aspects of the present invention.

As shown in FIG. 2, the distributed system 200 may be configured to perform any of the described functions, including but not limited to, storing, transmitting, editing, formatting, portioning, retrieving, and inserting information. System 200 may include one or more computer systems (e.g., systems 201, 203A-E) coupled by a communication network 205. Such computer systems may include, for example, general-purpose computer systems as discussed above with reference to FIG. 1.

In a media system practiced on a distributed system comprising multiple computer systems, each computer system may be configured to perform a specific function for the system. For example, in one embodiment of the present invention, system 201 is a database server that stores media, portions of media, and advertisements. System 201 may also store user information, such as demographic and/or contact information, schedule information, such as times and/or days, and advertising information, such as one or more advertisements, marketing plans, and/or advertising plans. Further, system 201 performs associated functions with the stored information, such as, for example, search and update functions.

System 201 may include a server process (e.g., process 207) that responds to requests from one or more client programs. Process 207 may include, for example, a structured query language (SQL) server or other server-based process that interfaces to one or more client programs distributed among the system 201 and/or other systems (e.g., systems 203A-203E) and provides access to database 209.

In some implementations, other computer systems, in addition to system 201, may also act as database servers. Such computer systems, including system 201, may be configured to execute a well-known database management program such as Microsoft's SQL server software or any other database management program. These database servers may be configured to respond to database access and update request from other computer systems. In some implementations, one database server may be configured as a master database server that distributes database requests to other database servers in order to maximize the speed of responding to database requests. In some implementations, the master database server may be configured to respond to database update requests and maintain an updated copy of the database on all other database servers. Each of the other database servers may be configured to respond only to database read or search requests. Such an arrangement may optimize a set of database servers for a situation in which many read/search requests are expected and few update/write requests are expected.

Other server-based processes being executed by the other computer systems may include a web server process, an XML server process, peer-to-peer process, a domain name server process, a routing server process, a schedule process, etc. In the case of a web server process 211A, the computer system 203A executing the process 211A may be configured to accept incoming hypertext transfer protocol (HTTP) requests from a user of the media system, for example through a web browser 215 being executed on a remote computer system 213 operated by the user.

Web browser 215 may direct requests through the Internet 217 to an edge routing device 219 associated with the media system (e.g., 200). Edge routing device 219 may direct the request to the web server 203A through the network 205. Web server process 211A may respond to the request by providing the requested information or performing the designated action. In some instances, web server process 211A may communicate with other computer systems to respond to the request. For example, web server process 211A may receive a request that requires an SQL database query or other database query, such as a schedule update. In that instance, web server 203A may convert the received HTTP request into an SQL or other database query for an SQL or other database server. Web server 203A may transmit the SQL or other database request to the SQL or other database server and, after receiving a response from the database server, respond to the initial HTTP request.

According to one embodiment, a process 211B executed by one of the computer systems 203B may be capable of managing a plurality of schedules of media transmission and transmitting portions of the media at scheduled times. Such a process 211B may monitor a time and/or day and distribute portions of media at times and/or days that match a schedule associated with the portions of media. In one embodiment, such a process 211B may include any type of application capable of communicating with the other computer systems of the system 200 through network 205 either directly or indirectly.

In one implementation, the process 211B may include a “cron” process configured periodically (e.g., every ten minute) to execute a scheduling script or other client program. For example, the client program may query a database server for schedules matching a current time and/or day or a set of times and/or days near the present time. In some implementations, a matching time may include any time between the execution periods of the program (e.g., ten minutes). For each such schedule, the process 211B may query the database server for a respective next portion of the associated media. In some implementations, process 211B may be configured account for time zone differences in scheduled times when querying for matching times and transmitting portions.

The client process 211B may then distribute the respective portion of the associated media when the current time matches the time associated with the respective schedules. In some embodiments, before transmitting the portion of media, the schedule process 211B or some other process (e.g., an advertising process) may insert one or more advertisements into the portion of media, for example according to an advertising plan associated with the media, a marketing plan associated with the advertisements and/or information associated with the recipient of the media. In other embodiments, one or more advertisements may be inserted into the portion of media before it is received from the database server, such as when the portion of media is submitted to the media server (e.g., by a distributor of the media).

For example, in the case of an electronic book, a chapter or other portion of the book may be retrieved from the database servers. One or more advertisements may then be inserted into the portion of the book, for example, at the beginning or end of the portion. When the desired time arrives, the portion may be transmitted to a user that requested the book.

According to one embodiment, the process 211B or another process such as process 211A or a dedicated process 211C executed by one of the computer systems 203C may be capable of accepting submission of a new schedule. In one embodiment, such a process 211C may include any type of application capable of communicating with the other computer systems of the system 200 through network 205 either directly or indirectly. For example, the process 211C may receive a representation of a schedule from a user. The representation may include an identification of a particular media, a destination of the portions of the media, and at least one day and/or time. In some implementations, the representation may also include a representation of a time zone. In some implementations, the process 211C may be configured to adjust a received time to a standardized time (i.e., a time in a standard time zone) based on a received time zone. In other implementations, the process may be configured to store a received time and a received time zone and another process (e.g., 211B may adjust for different time zones).

The process 211C may then transmit the scheduling information to the database server to be stored for future use. In some implementations, such a process 211C may be configured to accept updates to previously stored schedules. In some implementations, such a process 211C may be configured distribute portions of media at non-scheduled times in response to a users request for such non-scheduled portions, or to request previously transmitted portions to be retransmitted. A computer system or component configured to perform some or all of the acts associated with managing transmission and scheduling of media portions such as those described with respect to processes 211B and/or 211C may be considered schedule or transmission elements.

According to one embodiment, a process 211D executed by one of the computer systems 203D may be capable of managing media. In one embodiment, such a process 211D may include any type of application capable of communicating with the other computer systems of the system 200 through network 205 either directly or indirectly. For example, the process 211D may receive media from a distributor and store the media in the database server. In some implementations, the process 211D may divide the media into portions and stored in those portions in the database server (e.g., 201). In other implementations, the media may be submitted to the process from the distributors in portions. In still other implementations, the media may be stored in the database server as one whole piece of the media and divided into portions, for example by another process, according to each recipients desired portion size. In some embodiments, the process 211D may accept one or more advertising plans associated with the media. The plans may be stored in the database server and used to determine one or more advertisements to be inserted into the portions of media when they are distributed. A computer system or component configured to perform some or all of the acts of process 211D may be considered a media element.

According to one embodiment, a process 211E executed by one of the computer systems 203E may be capable of managing and/or inserting advertisements. In one embodiment, such a process 211E may include any type of application capable of communicating with the other computer systems of the system 200 through network 205 either directly or indirectly. For example, the process 211E may receive advertisements from an advertiser and store the advertisements in the database server. In some implementations, the process 211E may insert one or more advertisements into portions of the media distributed in accordance with the schedules managed by process 211B. In some embodiments, process 211E may accept one or more marketing plans associated with the advertisements and insert advertisements based on the marketing plans, advertising plans of the media, and/or characteristics of a recipient of the media. A computer systems or components configured to perform some or all of the acts of process 211E may be considered an advertising element.

Although separate computers processes 207, 211A-E communicating with one another have been described, it should be understood that embodiments of the present invention are not limited to any particular acts or arrangements of computer processes. For example, in some embodiments, one or more of the computer processes described may be implemented on a single computer system as a single computer process or multiple computer systems as multiple computer processes. In some embodiments different process acts may be performed in addition and/or as an alternative to the described acts.

For example, in one implementation, a process performing acts related to selling a complete media to a recipient of portions of the media may be included. Such a process may receive indication from recipients of an intent to purchase a media as well as other information related to such a purchase, such as billing and/or shipping information. Such a process may perform acts relating to billing the recipient and shipping/distributing the media to the recipient (for example, mailing a book or emailing a complete ebook to the recipient). In some implementations, such a process may be configured to access payment for a subscription to a media that requires such payment, for example when a licensing plan of the media requires payment for receipt of the portions of the media. As another example, some implementations may include a process related to maintaining a community of recipients or other users. Such a process may maintain forums, reviews, and/or groups of users, as described below.

### Example Database Information

In various aspects of the present invention, information regarding media, advertisements, users, and schedules may be stored on one or more storage devices. The storage devices may be associated with and managed by one or more database servers, as described above. The information may be stored and arranged in one or more database tables.

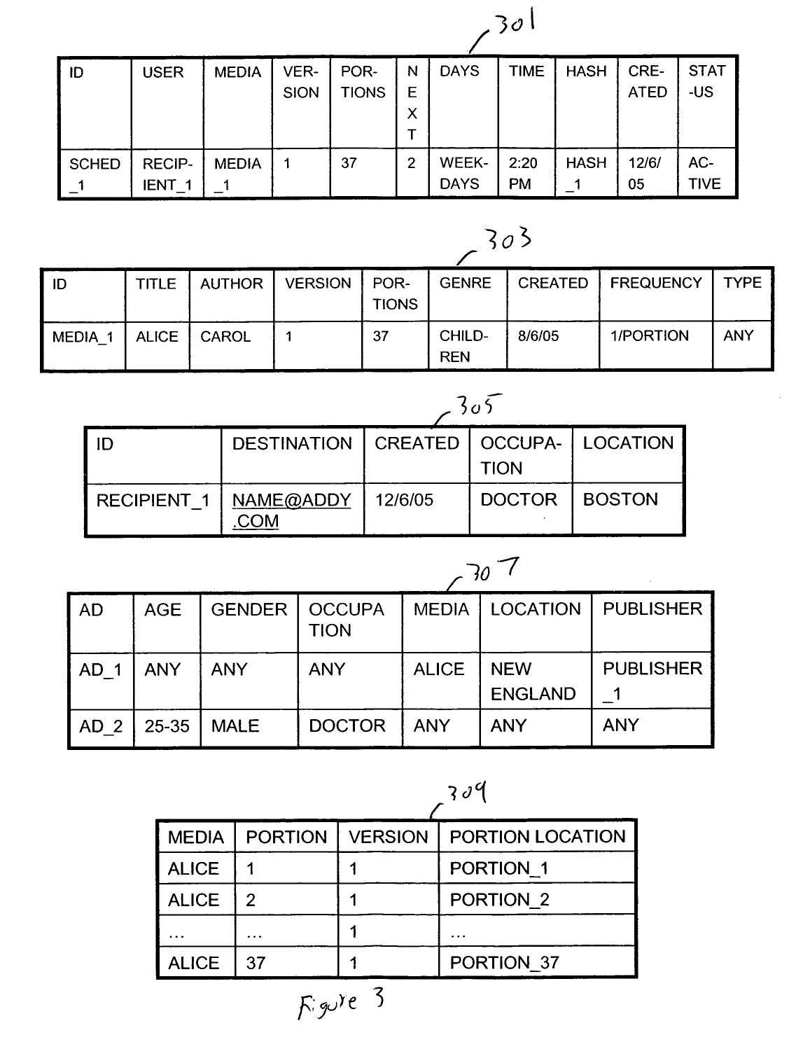

FIG. 3 illustrates a set of exemplary database tables for one embodiment of a media system in accordance with the present invention. The set of tables includes a schedule table 301, a media table 303, a user table 305, an advertisement table 307, and a portions table 309.

The schedule table 301 may include one entry for each on-going schedule (e.g., a schedule that has been started but not deleted) that identifies when to distribute portions of a media and identifies the media to be distributed. An entry for a schedule in schedule table 301 may include a unique identifier that may be used to identify the schedule. An entry in the schedule table may also include a unique hashed identifier that may be used, for example, by an external source to identify the schedule (e.g., as part of a URL). An entry for a schedule may also include an element for a recipient identifier. As illustrated in schedule table 301, the recipient identifier element may indicate a unique identifier that may be used to identify the recipient of the media portions (e.g., by referencing the recipient table described below). An entry in the schedule table may also include a creation date entry identifying the date at which the schedule was created.

In some embodiments, schedule table 301 may also include time and/or day elements. The time and/or day elements may indicate a next time and/or next day at which the next portion of a media should be distributed. In some implementations, the time and/or day elements may indicate any combination of times and days. Other implementations may allow only a single time per day. For example, the time and day indicated in schedule table 301 indicates media portions should be distributed at 2:20 PM on weekdays. In some implementations, the schedule table 301 may also include a time zone element indicating the time zone of a desired time. In such implementations, a query of a database may be performed for each time zone, for example, to determine upcoming scheduled transmissions. In some implementations, a time and/or day element may store a standardized time (i.e., a time that has been adjusted to a standard time zone). In such implementations, all times stored in schedule table 301 may be for a same time zone and a single database query may be performed to determine upcoming scheduled transmissions.

In some embodiments, schedule table 301 may include a media element identifying a particular media associated with the schedule. The media element may include a unique identifier that may be used to reference a media table, as described below. In addition, in some embodiments, the schedule table may also include a portion element indicating the next portion of the associated media to be distributed.

In some embodiments, as illustrated in FIG. 3, schedule table 301 may include a status element. The status element may indicate the current status of the schedule. For example, schedule 301 indicates that the shown schedule is “ACTIVE.” In some implementations, other available statuses may include pending, in which the media system may await a verification of the existence of the recipient before sending a first portion (e.g., from a verification email as described below), suspended, in which the media system may pause transmission of media portions until a user indicates a continuation of such transmission, and completed or deleted, in which the user has ended transmission either by his or her own selection or by receiving the final portion of the media. In some implementations, when a user selects to delete a media and/or a media finishes transmission, the associated schedule entry in schedule table 301 may be removed from the table. In some implementations, rather than removing such an entry, a status indicator associated with the entry may be set to a finished or deleted state.

In some embodiments, entries in the schedule table may include a version identifier. The version identifier may be used to specify a particular version of the identified media in systems configured to support multiple versions of a single media. Multiple versions may, for example, allow changes to a media, such as corrections or updates, and changes to the number and/or size of the portions. Different versions of the media, for example may have different sets of portion breaks (i.e., end of one portion and beginning of another portion). Multiple versions may also allow different sets of content for the same media, for example, a radio version of a song. In some implementations more recent versions of a media may replace older versions of the media. Users subscribed to an older version may continue to receive portions of the older version in some implementations. As new users subscribe to the media, they may be subscribed to the new version of the media. Such an implementation permits media changes while maintaining subscriptions of prior subscribers.

In some implementations, the subscription table may include an entry indicating a total number of portions in the media (or the particular version of them media). Such an entry may be used, for example, to identify the end of a particular schedule.

In some embodiments, media table 303 may include at least one entry for each media of the media system. In some embodiments, media table 303 may include a media identifier element that uniquely identifies each media of the media system (e.g., a unique identifier number). Media table 303 may include a title element that identifies the media title (e.g., “ALICE”). Media table 303 may include an author element that identifies the media author (e.g., “CAROL”). Media table 303 may include a created data element that identifies the date at which the media way entered into the system. Media table 303 may include a portions element that identifies the total number of portion each respective media has been divided into.

In some implementations in which different versions of media are supported by the media system, the media table 303 may include a version element that identifies a current version of the media that may be used to associate a particular version of the media with new schedules. In some implementations, the media table 303 may include an element identifying the genre and/or categories of each piece of media.

In some embodiments, media table 303 may include an element indicating a number of portions. This element may indicate the total number of portion into which the associated media is or should be divided. In some implementations, the number of portions may be based on the size or length of the media and a reasonable size or length to be viewed/listened to by a recipient at the schedule time (e.g., while checking email). In some implementations, the number of portions may be indicated by a distributor of the media, for example, when the media is submitted to the media system.

In some embodiments, media table 303 may include elements indicating at least one advertising plan associated with each piece of media. As illustrated in FIG. 3, media table 303 includes an element indicating types of advertisements and frequency of advertisements. Such elements may be used to indicate specific advertisements or types of advertisements to include or exclude from insertion into the portions of media. Such elements may also be used to indicate a number of advertisements to include in each portion of media. As illustrated in media table 303, the media “ALICE” may have a single advertisement inserted into each portion of the media, and the advertisement may be any advertisement. In some other instances, the advertisements may be limited to a specific advertising category, such as children's advertisements, specific profession related advertising, and/or advertisements from a particular publisher or source.

In some embodiments, the elements indicating the advertising plan may include elements indicating a licensing plan or other licensing information. The licensing plan elements may indicate one or more available licenses through which the portions of the media may be distributed to the recipients. In some implementations, the licensing plan elements may indicate that recipients may receive the portions for free. In some implementations, the licensing plan may indicate that recipient must pay a fee to receive at least some and/or all of the portions of the media. In some implementations, the licensing plan may indicate a cost charged to an operator of the media system for each recipient receiving portions of the media and the operator may insert advertisements into the portions in order to pay the cost.

In some embodiments, user table 305 may include at least one entry for each recipient of media portions from the media system. The user table may include an identifier element that may include a unique identifier for each recipient entry that may be used to identify the respective recipient. The user table may include a destination element indicating an email address or other destination indicator for media portions sent to each respective recipient (e.g., “NAME@ADDY.COM”). The user table may also include a created element that identifies the date each user entry was first created.

In some embodiments, user table 305 may include elements indicating recorded information regarding each recipient. In some implementations, the demographic information may include age, gender, name, location, ethnicity, education, profession, income, and any other information. In some implementations, the information may be used to determine one or more advertisements to be inserted into one or more portions of media distributed to a respective recipient.

In some embodiments, advertisement table 307 may include an entry for each advertisement of the media system. In some embodiments, advertisement table 307 may include an element identifying the advertisement. Such an element may indicate a physical location of an advertisement on a storage system or a logical identifier of an advertisement that may be used by another system to retrieve the advertisement. In various embodiments, the advertisements may be in any format and in any medium, including a format and medium that is the same as the media in which the advertisement may be inserted.

In some embodiments, advertisement table 307 may include one or more elements indicating one or more marketing plans for each advertisement. In some implementations, such targeting elements may include indications of a source of the advertisement, a preferred age range, a preferred gender, a preferred occupation or occupation type, a preferred media list, a preferred location, a preferred genre, a cost associated with insertion of the advertisement, and/or an associated or preferred publisher (e.g., a target publisher and/or a publisher providing the advertisement).

In some embodiments, portions table 309 may include at least one entry for each portion of each media of the media system. In some embodiments, portions table may include a media identifier indicating the media (e.g., an identifier of the media) and portion number for each entry. In some implementations that support multiple versions of a media, the media identifier may include a version number that indicates to which version of a media each portion is associated. In some embodiments, portions table 309 may include a portion element identifying a portion associated with each respective media element. In some implementations, the portions elements may indicate a physical address on a storage medium on which the portion may be stored and accessed. In some implementations, the portions elements may indicate a logical identifier of a portion that may be used by another system to retrieve the respective portion.

The illustrated set of database tables in FIG. 3 allows a search to be easily performed for upcoming and/or current schedule matches, advertisements, user information, and media portions. For instance, a search for a time range and day within the schedule table may identify each upcoming scheduled portion transmission. A search for a particular recipient's demographic or other information may be performed by a query to the user table indicating a particular recipient's email or other recipient identifier. A search for a particular portion of a desired media may be performed through a query to the portion table indicating the portion number and media name. Advertisements may be searched for matching target information by querying the advertisement table for advertisements matching such target information.

It should be understood that the tables of FIG. 3 are given by example only. Other embodiments of the present invention may include any other collection of database tables or other collections of information that may be used to distribute portions of media in accordance with a schedule and/or insert advertisements into the portions.

### Example Processes and Interfaces

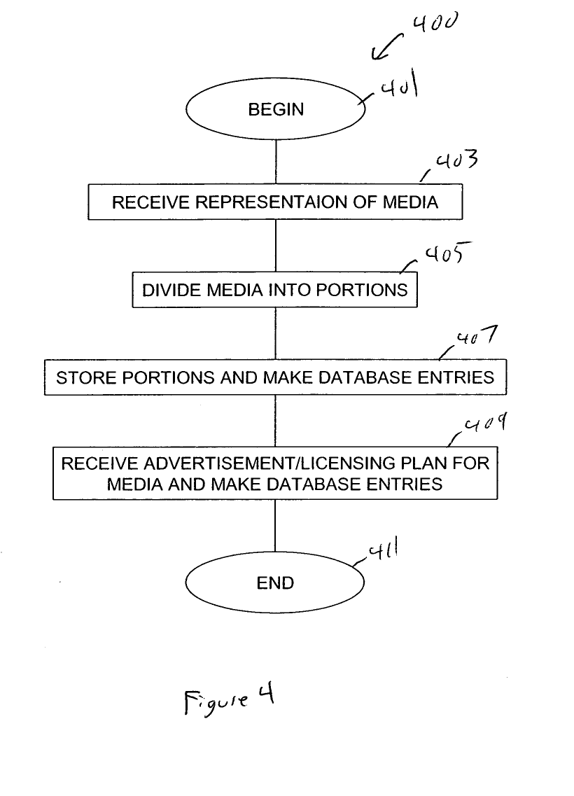

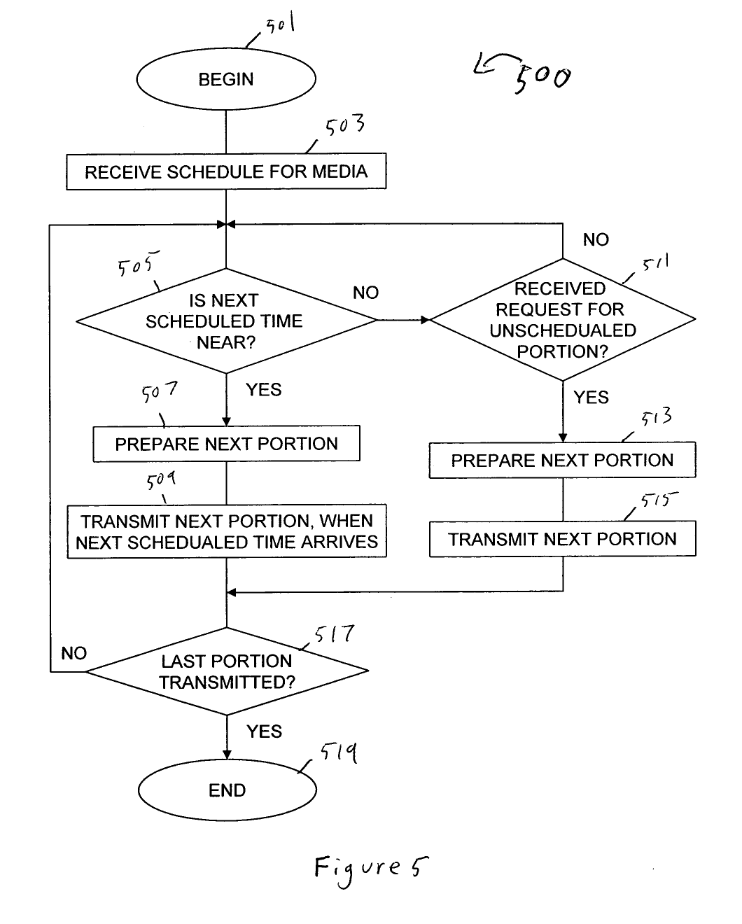

FIGS. 4 and 5 illustrate example processes that may be performed by a media system in accordance with some embodiments of the present invention. It should be understood that the processes are illustrated as examples only and that various embodiments of the present invention may perform any set of processes to distribute portions of a media in portions according to a schedule and/or insert advertising into the portions of the media.

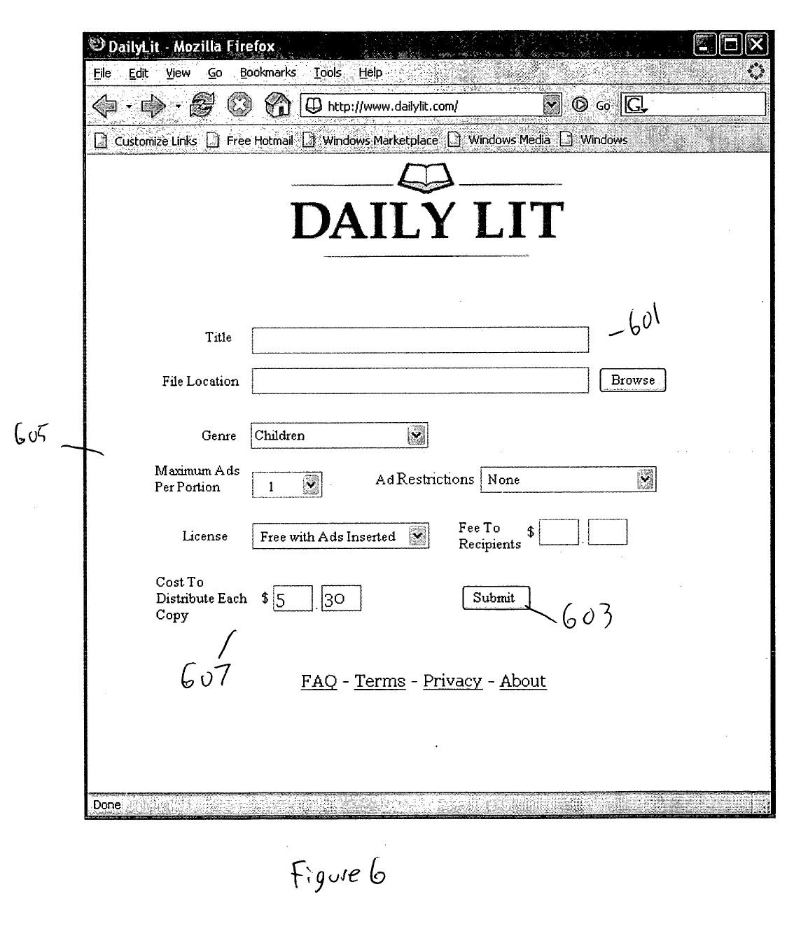

FIG. 4 illustrates an example process 400, which begins at Block 401, for accepting a media from a distributor. Some embodiments of a media system in accordance with one embodiment of the present invention may first receive at least one representation of a media, as indicated at Block 403. In some embodiments, the representation may be received from, for example, a distributor of a piece of media, such as a publisher or creator, and/or from a repository of media, such as a digital library of media. In some embodiments, the media system may provide a distributor with one or more interfaces with which to submit the media. In some implementations, the interfaces may include one or more websites accessible through the Internet by a web browser. One example interface through which a distributor may submit a media is illustrated in FIG. 6. In such an interface, the distributor may identify the media through using identifier boxes 601 and submit the media by clicking submit button 603. In some implementations, the distributor may enter additional information, such as an advertising plan through advertising boxes 605, and/or a cost to the operator of the media system for each copy of the media distributed to recipients through the cost box 607. In some implementations, a media system may accept representations of the media from other users of the system, such as recipients, media reviewers, and/or forum contributors (described below).

In various embodiments, the media may include any type of media. For example, in some embodiments, the media may include one or more of music, video, at least one image, and textual information. In some embodiments, the media may include a movie, a song, an audio book, a television show, a graphic novel, an electronic book (ebook), and/or another written work. The representation of the media may be received in any format readable by the media system. For example only, some embodiments of the media system may accept representations in AVI, MPEG, MP3, plain text, HTML, and/or PDF formats.

As indicated at Block 405 of FIG. 4, after receiving the representation of the media, the media system may divide the media into portions. In other embodiments, however, the media may be received in Block 403 already divided into portions from a distributor and the process may continue to Block 407. In still other embodiments, the media system may not divide the media into portions at this point but rather may dynamically divide the media into portions at another time before distributing the portions to a recipient. For example, in some implementations, the media may be divided into portion according to a portion size selected by each recipient, thereby allowing each recipient to customize the delivery of the media. In some such implementations, the media may be stored as an entire piece of media and divided individually into different portions for each recipient of the media. In other implementations, the media may be divided into multiple sets of portions of different sizes and stored as the multiple sets so that recipients may choose one of the sizes when establishing a schedule as described below.

In the illustrated embodiment, the media system may divide the media into one set of portions that may be comfortably readable by a recipient each day and/or time of an associated schedule. In some implementations, the size of the portions may be a number of pages of a textual media, for example between about one and ten pages. In some implementations, the size of the portions may be a number of chapters of a textual media, for example about one chapter. In some implementations, the size of the portions may be a length of a video or audio file. In some implementations, the size of the portion may be based on a break or scene change in a video or audio file. In some implementations, the size of the portions may be based, at least partially, on a size of the media. In some implementations, the size of the portions may be based, at least in part, on metadata included in the media, for example, a chapter break, page break, scene break, paragraph count, word count, character count, byte count, or other metadata inserted by a distributor or other source of the media to indicate a portion break.

In some embodiments, one or more users of the media system, such as recipients of other media or users of a forum or other such service discussed below or an administrator of the media system, may divide some media into portions or revise the portions automatically created by the media system. In some implementations, this user input may improve the process of dividing the media into portions by allowing users to divide the media themselves according to their own opinions which may be shared by future recipients, thereby avoiding, for example, portion breaks in the middle of a scene.

As indicated at Block 407, the media system may store the portions of the media on at least one storage medium and make any necessary database entries that may later be used to access the portions, as described above with respect to the example database tables. In other embodiments, the media system may insert advertisements into the stored portions. The portions may be stored in any format, including but not limited to the format in which the media was originally received in Block 403.

As indicated at Block 409, the media system may also receive at least one advertising plan and/or licensing plan for the media and record that plan in a database as described above with respect to the example database tables. Such advertising plan may give distributors of media more control over the marketing and distribution of their media. In some implementations, as described above, a distributor may submit such information with the media through the advertising plan boxes 605 of the interface illustrated in FIG. 6, a distributor of the media may submit such an advertising plan through an interface used to submit the media. In some embodiments, the advertising plan may indicate one or more advertisement or advertisement types to include and/or exclude when inserting advertisements into the portions. For example, the advertising plan may indicate a preference for advertisements directed at particular products types, genders, occupations, age ranges, etc. In some embodiments, the advertising plan may indicate a frequency of advertisements to include. For example, the advertising plan may indicate the number of advertisements to include per portion. In some implementations, the advertising plan may indicate a limitation on advertisements to only those advertisements that are associated with the distributor of the media. In some implementations, the advertising plan may indicate whether third-party advertisements may be inserted into the media portions or whether only in-house advertisements of the distributor may be inserted into the portions. In some implementations, the advertising plan may include metadata within the media identifying potential/recommended locations for advertisement insertion.

In some implementations, the advertising plan may include a licensing plan that may indicate that the media should be distributed for free to recipients if advertisements are inserted, be distributed only for a desired fee with/without advertisements inserted, and/or any other combination of fees and advertising plans. In some implementations, a licensing plan may indicate that a set of preview portions may be distributed without advertisements insert and a set of subscription portions may be distributed with advertisements inserted. In some implementations, the licensing plan may indicate that the preview portion may be received for free and that the subscription portion may be received only for a fee. In some implementations, the licensing plan may indicate a cost to an operator of the media for each recipient to which the portions of the media are distributed.

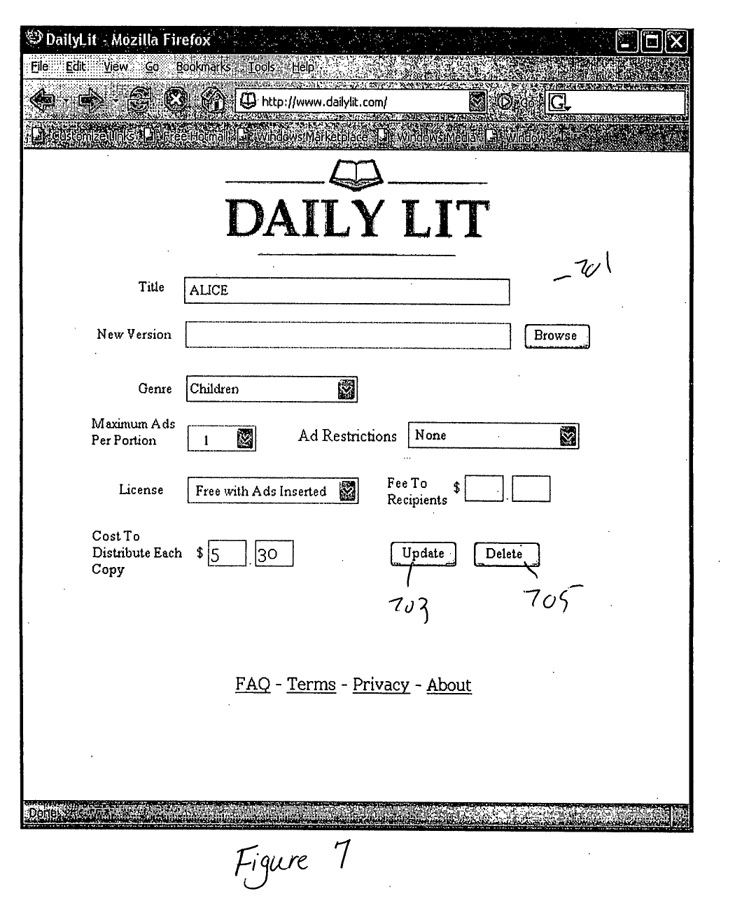

In some embodiments, the media system may allow a distributor of the media to manage an advertising plan, including a licensing plan, and other information regarding the media. By allowing a distributor to change the advertising plan, the media system may give distributors of media more control over the distribution and marketing of their media as target markets of that media change. In some implementations, the media system may provide an interface, such as a website, through which the distributor may manage the licensing plan and/or advertising plan associated with the media. An example interface that may be used by a distributor to manage an advertising plan is illustrated in FIG. 7. Through such an interface, a distributor may edit advertising information and other information such as the cost to distribute the media through the update boxes 701 and submit the updated information by clicking update button 703.

Through such an interface, a distributor may also update a version of the media and remove the media from the system. For example, in the illustrated example, a distributor may provide a new updated copy of the media that may be provided to new recipients of the media. As described above with respect to the database tables of FIG. 3, versioning elements may be updated so that prior recipients of the media continue to receive an older version of the media and new recipients of the media receive the newly submitted version. The media may be deleted from the system by clicking the delete button 705.

As indicated in FIG. 4, process 400 may end at Block 411.

FIG. 5 illustrates a process 500 for accepting a schedule from a recipient and providing the recipient with portions of a media according to the schedule that begins at Block 501. In some embodiments, the process may begin by receiving at least one representation of a schedule from a recipient, as indicated at Block 503.

In some embodiments, the schedule may identify one or more of the media to be received, the recipient of the media, a version of the media, and one or more of a time and/or a day on which to receive the media. In some implementations, the media may be identified by title or other unique media identifier. In some implementations, the recipient may be identified by an email address of the recipient. In other implementations, the recipient may be identified by a login name and password. In still other implementations, the recipient may be identified by an address associated with an RSS feed and/or a cell phone number to which MMS and/or SMS messages (or other text or media messages) may be distributed.

In some embodiments, the time and/or day may indicate when the portions of media should be distributed to the identified recipient. In some implementations, the time and/or day may include any combination of a set of days and a set of times. In some implementations, the time and/or day may include a selection of weekdays and/or weekend days. In some implementations, the time and/or day may include a single time and one or more days. In other implementations, the schedule may include one or more portion sizes indicating the size of each portion to be distributed. In some implementations, the submission of a schedule may include submission of one or more fees for receiving the portion of media in accordance with a licensing plan associated with the media. In other implementations, the receipt of media may be free to the recipient and paid for through the insertion of advertisements. In some implementations, submission of a schedule may include submission of information regarding the recipient, such as demographic information, that may be used to target advertisements at the recipient.

In some implementations, the representation of the schedule may also include an indication of a time zone. In such an implementation, the time and/or day received, as described above, may indicate a time and/or day in the time zone. As described above, some implementations may store the indication of the time zone. As described above, other implementations may adjust the time and/or day to a standardized time and/or day based on the indication of the time zone.

In some implementations, the representation of the schedule may also include an indication of a number of portions to transmit at the time and/or day. While in some implementations, only a single portion may be transmitted at the time and/or day, in other implementations, a recipient may customize the number of portions transmitted. This may allow recipients that read or otherwise consume media quickly to receive larger amounts of media at one time.

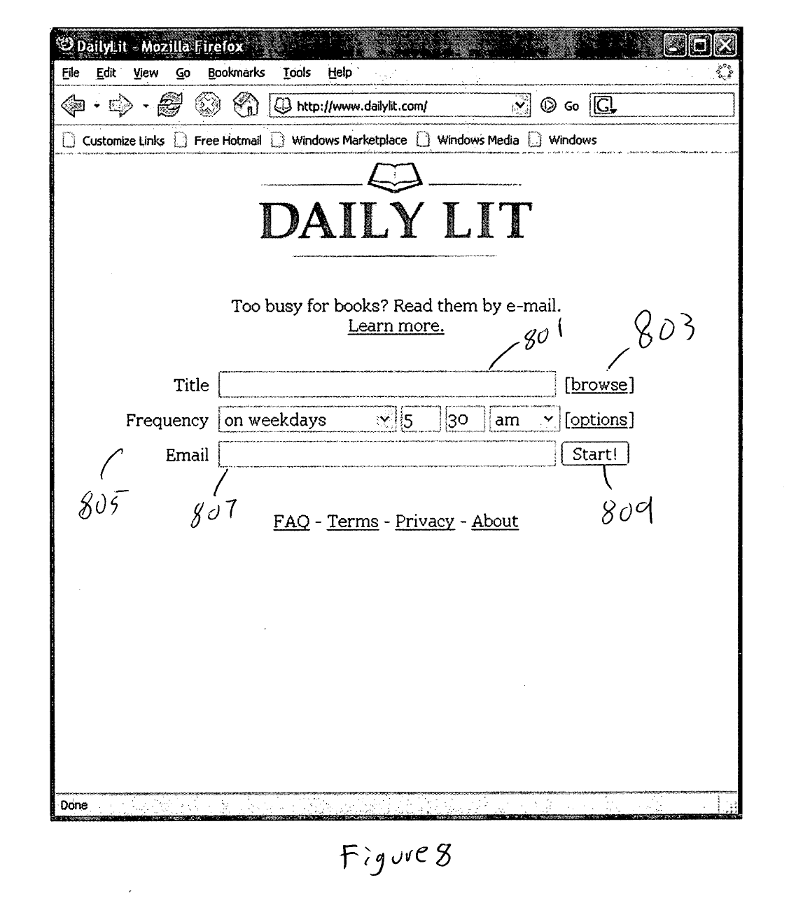

In some embodiments, to facilitate submission of such schedules, the media system may provide the recipient with an interface. In some embodiments, the interface may include one or more websites accessible through the Internet by a web browser so that many Internet users may access the interface. One example interface for submission of a schedule is illustrated in FIG. 8. In the illustrated interface, a recipient may enter the name of a media in title box 801 or search for available media by clicking on the browse link 803. The recipient may also select days and times at which portions may be distributed through frequency boxes 805. The recipient may also enter a recipient email address in email box 807. The recipient may submit the schedule defined by the entries in each of boxes 801, 805 and 807 by clicking on the start button 809. In some implementations, such an interface may include one or more requests for other information, such as demographic information, which may be used to target advertising at the recipient.

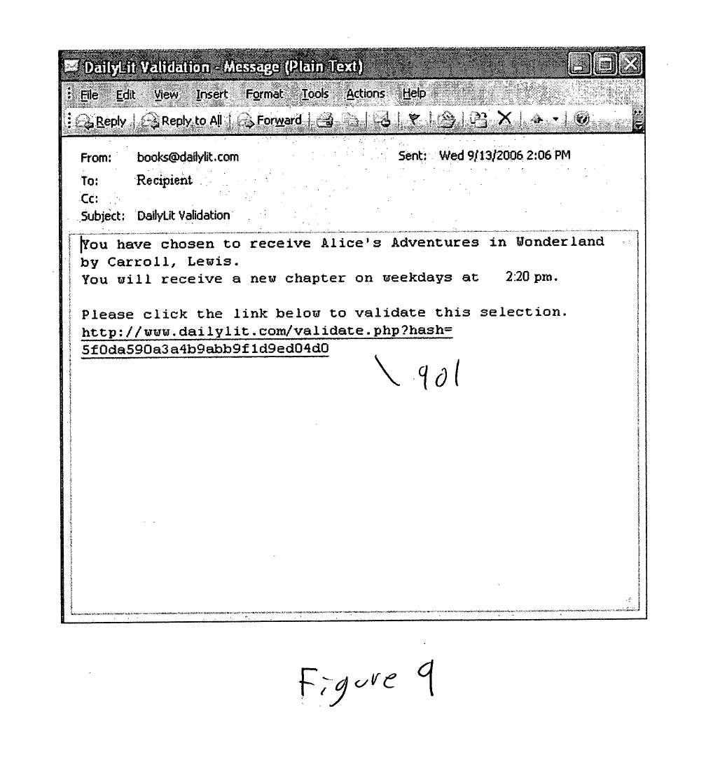

In some embodiments, before beginning transmission of the portions of the media, the media system may perform a validation process. Such a validation process may help assure that an identified recipient does actually desire to receive the identified media. Such validation systems may be used, for example, in “account-free” media systems in which a recipient is not required to establish a separate account before receiving media. The validation process may include distributing a validation message to the recipient and awaiting a response before distributing the portions of the media to the recipient. The validation message may include a validation email, SMS message, and/or MMS message. One example validation email is illustrated in FIG. 9. In the illustrated example, the recipient may respond to the validation message by clicking on validation link 901. Clicking on validation link 901 may transmit an HTTP message to the media system identifying that the recipient has validated the schedule. In some implementations, the validation message may include one or more requests for other information, such as demographic information, which may be used to target advertising at the recipient.

In some embodiments, before beginning transmission of the portions of the media, the media system may perform a registration process. The registration process may be used to create an account for new recipients. Previously registered recipient may not be required to register, but instead may identify themselves as previously registered by providing, for example a username and password. Such a registration process may ease the tracking of registered recipient's preferences, such as previous media requested; however, such tracking may still occur in an “account-free” media system by recording media distributed to each recipient address (e.g., email address). In some implementations, the registration process may also include a validation process, as described above. In some implementations, the registration process may be performed through one or more registration interfaces, such as one or more websites. In some implementations, the registration process may include one or more requests for other information, such as demographic information, which may be used to target advertising at the recipient.

In some embodiments, process 500 may include an act of determining if a scheduled time has arrived, as indicated at Block 505. In some embodiments, to determine if a scheduled time has arrived, the media system may compare the current time and/or day with the time and/or day associated with each schedule stored, for example, in the database tables of FIG. 3. In some implementations, such a comparison may include an adjustment for a time zone that may be stored with the schedules. In some implementations, a schedule process may periodically query the database tables for schedules associated with times and/or days within a range of the current time and/or day. In some implementations, the schedule process may retrieve schedules information before the associate time and/or day arrives so that preparation acts, such as those described below, before distributing the next portions associated with the retrieved schedules when the schedule times and/or day of each respective matching schedule arrives. In some implementations, only active schedules (e.g., schedules with a status of “ACTIVE,” as described above) may be considered when determining which scheduled times and/or days are near.

As indicated at Block 507, the media system may prepare a next portion of the media for transmission when the scheduled time and/or day is near. In some embodiments, such preparation may include retrieving the next portion associated with the schedule from one or more storage devices. Such retrieving may be performed by identifying the next portion from a database entry in the schedule table and retrieving the portion from the portions table, as described above with respect to example database tables in FIG. 3. In some other embodiments, the preparation may include dividing the media into the next portion based on a recipient specified portion size included in the submission of the schedule. In some embodiments, retrieving the portion may include retrieving a portion associated with a particular version of the media.

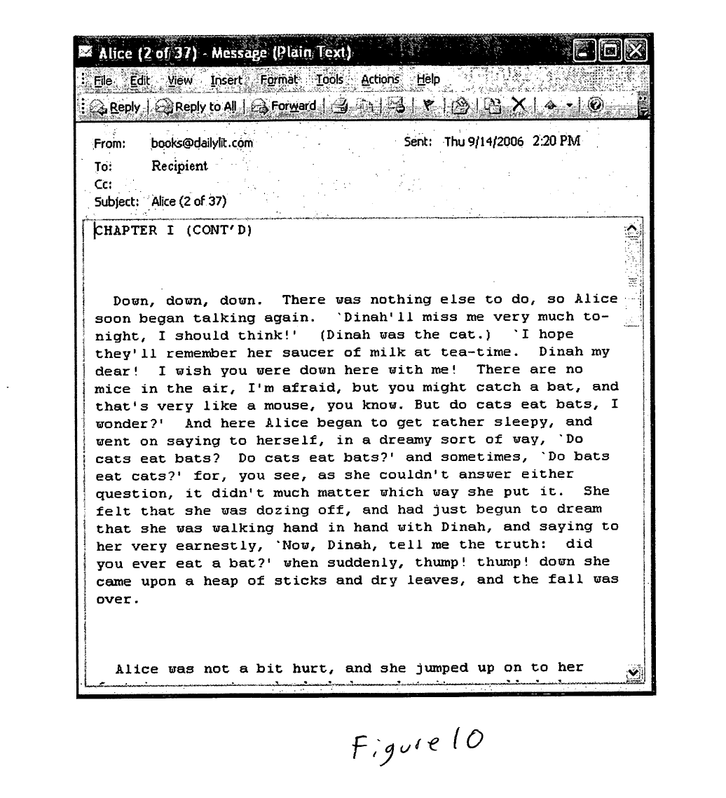

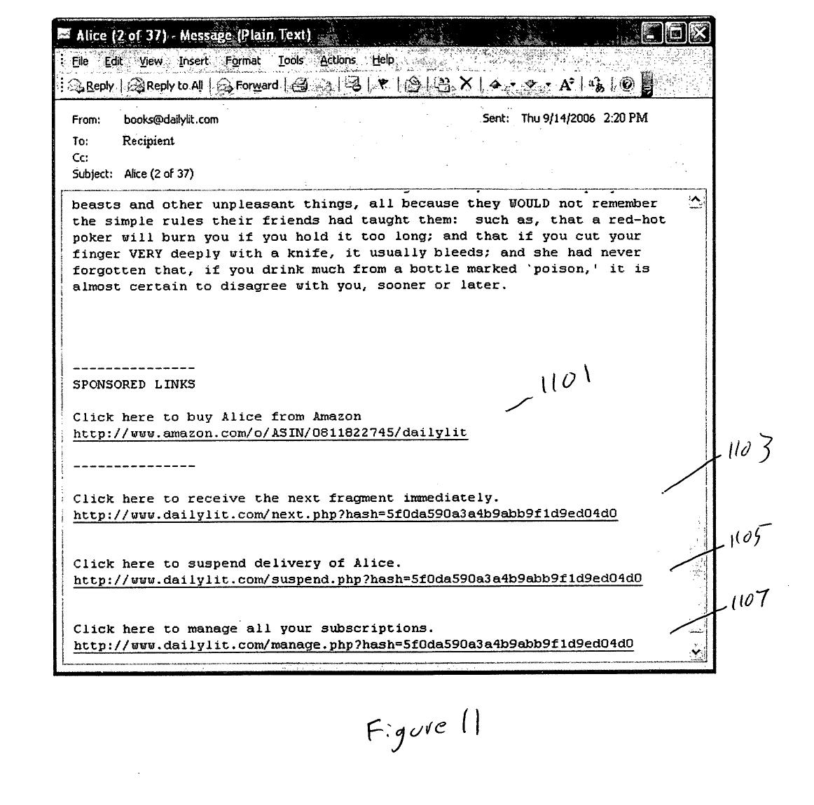

In some embodiments, the preparation of the next portion may include generating an email message into which the next portion may be inserted. By transmitting email messages to distribute the portions of the media, recipients may be more likely to view/listen to the portions of media when the recipients check their email. An example portion of media prepared as an email message is illustrated in FIGS. 10 and 11. In other embodiments, the portions may be inserted into SMS, MMS, and/or RSS feed in addition to or as an alternative to email messages.

In some embodiments, the preparation may include inserting one or more advertisements into the next portion of the media. In some implementations, the advertisements may be inserted into an email message, SMS message, MMS message, and/or RSS feed, for example, at the beginning or end of the message. In some implementations, the advertisement may be inserted within the portion media, such as between scenes or pages of the media. In some implementations, the advertisements may be inserted in locations identified by metadata within the advertisements such as at page breaks, chapter breaks, line breaks, scene changes, track changes, an/or other metadata identifying placement of advertisements inserted by the distributor of the media or other user of the media system prior to submission or after submission of the media described with respect to FIG. 4.

As described above, in some embodiments, the advertisements may be inserted according to one or more advertising plans associated with the media. Such advertising plans may give control over the content of portions to the distributor of the media as well as allow more focused advertising making advertisements more effective and thereby allow operators of media system to obtain higher or more advertisement fees from advertisers. For example, the media system may determine which advertisements to insert by selecting advertisements from the advertisement table illustrated in FIG. 3 that have matching characteristics to those of characteristics identified in the advertising plan of the media (e.g., a matching genre, title, or author). In some implementations, where multiple advertisements have the same number of matching characteristics to a media, the higher paying advertisements may be chosen before lower paying advertisements (e.g., advertisements that will make the media system more money may be inserted first).

In some implementations, the media system may select a number of such advertisements equal to a number of advertisements indicated in the advertising plan. In other implementations, the media system may operate having a single advertising plan that applies to all media. In still other implementations, the media system may operate having a default advertising plan that applies to all media unless it is changed by a distributor of the media, as described above.

In some embodiments, in addition to or as an alternative to selecting advertisements based on an advertising plan associated with the media, advertisements may be directed at the recipients based on a marketing plan of the advertisements. For example, the marketing plan may match advertisements to characteristics of the recipients. Matching advertisements with recipients having characteristics associated with a target market of the advertisements may improve the effectiveness of the advertisements and thereby allow an operator of a media system to obtain higher or more advertisement fees from advertisers. For example, as indicated in FIG. 3, a database entry for an advertisement may include one or more marketing characteristics identifying preferred recipients of the advertisements. The advertisements may be selected for insertion based on similarities among/between the marketing characteristics and characteristics of the recipients. For example, the marketing characteristics may include demographic information regarding a target recipient and/or information regarding the media, such as a preferred genre, a preferred medium, a preferred publisher, a preferred author and/or a preferred title. In some implementations advertisements having a minimum number or percentage of matching characteristics may be chosen for insertion into the portions. In some implementations, an advertisement having the most matching characteristics may be chosen for insertion. In some implementations, where multiple advertisements have the same number of matching characteristics to a recipient and, in some implementations, a media (as discussed above), the higher paying advertisements may be chosen before lower paying advertisements (e.g., advertisements that will make the media system more money may be inserted first).

In some implementations, the inserted advertisements may be monitored so that a particular advertisement is repeated only occasionally or not at all while a media is distributed in portions over the schedule. Advertisement 1101 of FIG. 11 illustrates a text advertisement inserted within a prepared email message containing a portion of the media.

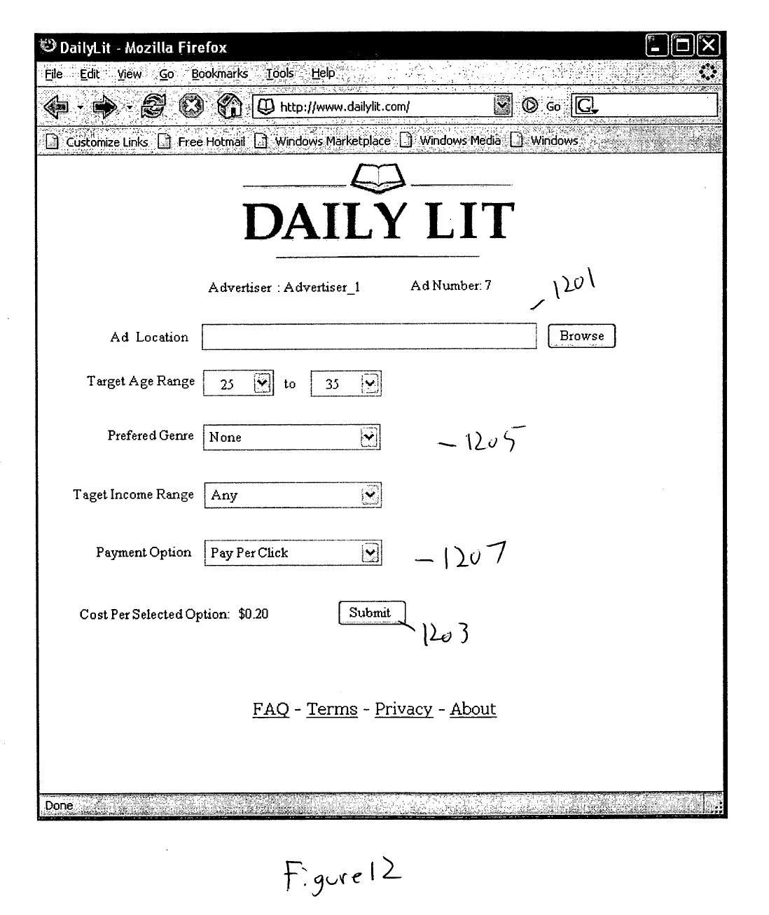

The advertisements may be received before the insertion into the media from one or more advertisers. In some implementations, a marketing plan may be received to indicate characteristics for targeting the advertisements. The advertisements and marketing plans may be submitted to the media system through one or more interfaces, such as one or more websites. FIG. 12 illustrates an example interface through which an advertiser may submit an advertisement to the media system. The advertiser may identify the advertisement through identity box 1201 and submit the advertisement by clicking the submit button 1203. In the illustrated interface, the advertiser may also enter a marketing plan through marketing boxes 1205.

An operator of a media system according to some embodiments of the present invention may be paid by an advertiser. Payments from the advertisers may be used, for example, to pay media distributors for any fees they may require to distribute the media. In some implementations, the advertiser may pay the operator for each advertisement of the advertiser that is inserted into a portion of media. In some implementations, an advertiser may pay more for a targeted insertion of an advertisement than an untargeted insertion. In some implementations, the advertiser may pay the operator each time a recipient clicks on an advertisement of the advertisers. In some implementations, the advertiser may pay the operator each time some other event related to the advertisements of the advertiser occurs, such as each time a recipient purchases a product advertised in an inserted advertisement after clicking on a link associated with the advertisement. In the illustrated interface of FIG. 12, the advertiser may also select a payment method for the advertisement (e.g., cost per click (CPC), pay per insertion (CPM), pay per product purchase (CPA), flat fee) and view a cost associated with that option through the payment interface 1207.

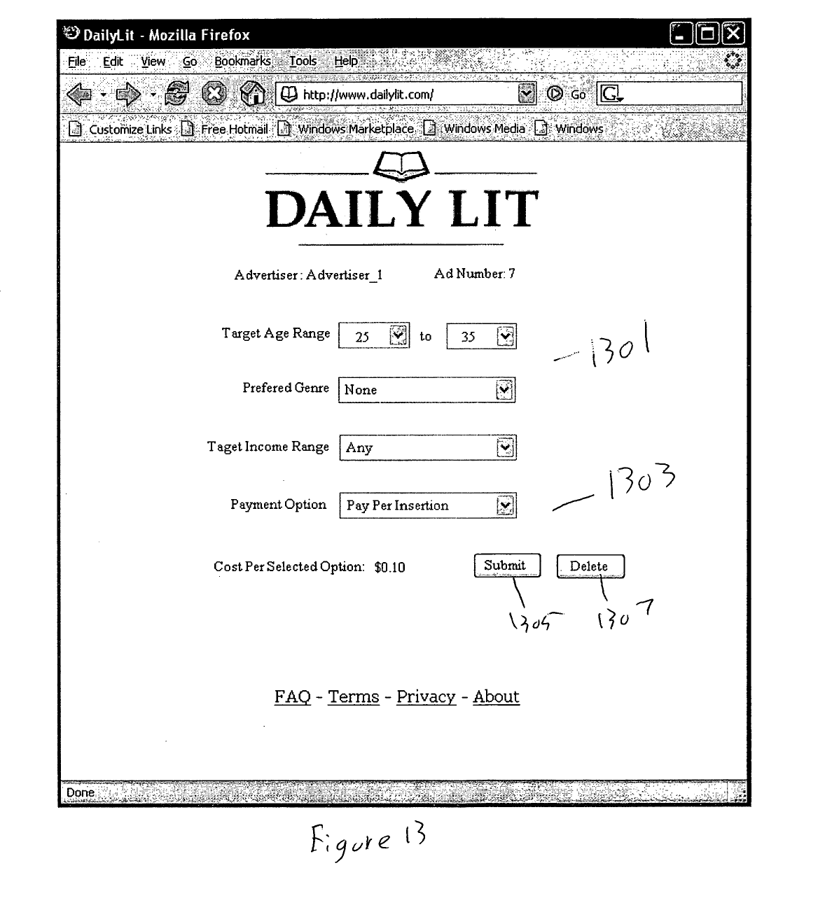

In some embodiments, an advertiser may change an advertisement, delete an advertisement, change a payment option, and change a marketing plan for the advertisements through one or more interfaces after submitting the advertisement, for example if a target market or advertising campaign changes. FIG. 13 illustrates an example interface through which an advertiser may perform such action. For example, an advertiser may change a marketing plan of an advertisement by editing entries in marketing boxes 1301. An advertiser may change payment options through payment interface 1303. The advertisement may submit any changes by clicking update button 1305. As illustrated in FIG. 13, in some implementations, an advertiser may delete the advertisement from the media system by clicking on delete button 1307.

In some embodiments, preparation of the next portion may include insertion of additional information into the next portion. In some implementations, the additional information may include options for controlling the schedule of the media transmission, as illustrated by links 1103, 1105, and 1107 illustrated in FIG. 11.

As indicated at Block 509 of FIG. 5, after preparing the portion for transmission, the media system may distribute the portion to the recipient when the scheduled time and/or day arrives. The media system may compare the current time and day to the scheduled time and day associated with the schedule of the prepared portion and distribute the portion when the current time and/or day matches the scheduled time and/or day. Distributing the portion of the media may include transmitting an email message, SMS message, and/or MMS message to the recipient and/or distributing the portion to an RSS feed.

As indicated at Block 511, some embodiments of a media system in accordance with the present invention may accept request for delivery of unscheduled portions of the media to which a recipient is subscribed. By allowing this unscheduled transmission, the recipient of the media may have more control over the delivery of the media and obtain additional portions as time to view/listen to the portions becomes available outside of the scheduled times/days. For example, link 1103 of the portion of media illustrated in FIG. 11, illustrates a link through which the recipient of the portion may transmit such a request. By clicking on link 1103, the recipient may transmit an HTTP message to the media system requesting the next portion of the media.

As indicated at Blocks 513 and 515, if such a request is received, the media system may prepare a next portion to distribute, similar to the process described with respect to Block 509, and distribute that next portion, similar to the process described in Block 509.

After distributing the next portion, either at Block 509 or Block 513, the media system may update any database entries tracking the portions which have been distributed. The media system may also check if the last portion of the media has been distributed, as indicated at Block 517 of FIG. 5. If the last portion has not been distributed, the process 500 may loop back to Block 505 and await either a request for a next portion in Block 511 or a scheduled time and/or day to arrive. If the last portion has been distributed, the process may end at Block 519.

In some embodiments, a media system in accordance with some embodiments of the present invention may permit a recipient to manage details of one or more schedules. Allowing such management may allow a recipient to alter a schedule to match changes in the recipient's personal schedule, cancel transmission of media the recipient no longer wants to receive, and/or suspend transmission of the portions when the recipient's personal schedule becomes too busy. For example, as indicated by links 1105, a recipient may be supplied with a link in the supplied portions of media through which the recipient may suspend a schedule. By clicking on link 1105, the recipient may transmit an HTTP message to the media system indicating a request for suspension of the schedule. When the media system receives such a suspension indication, the media system may update appropriate database entries and stop distributing portions of media to the recipient until the recipient either requests a next portion (e.g., by clinking link 1103) and/or unsuspends the schedule of transmission.

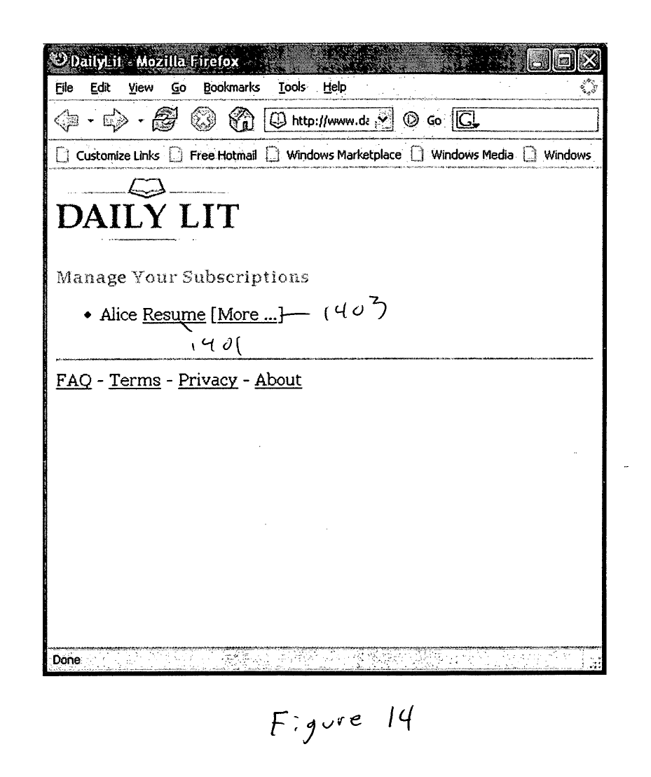

In some embodiments, a user may unsuspend a schedule and otherwise manage schedules through a management interface such as the one illustrated in FIG. 14. The recipient may access the management interface, for example by clicking on link 1107 of FIG. 11. In other implementations, the recipient may access such an interface by logging on to the media system, for example, using a username and password. In some implementations, the recipient may resume a suspended schedule by clicking on a resume link 1401. In some implementations, if the schedule is not suspended, a user may suspend the schedule by clicking on a suspend link (not shown).

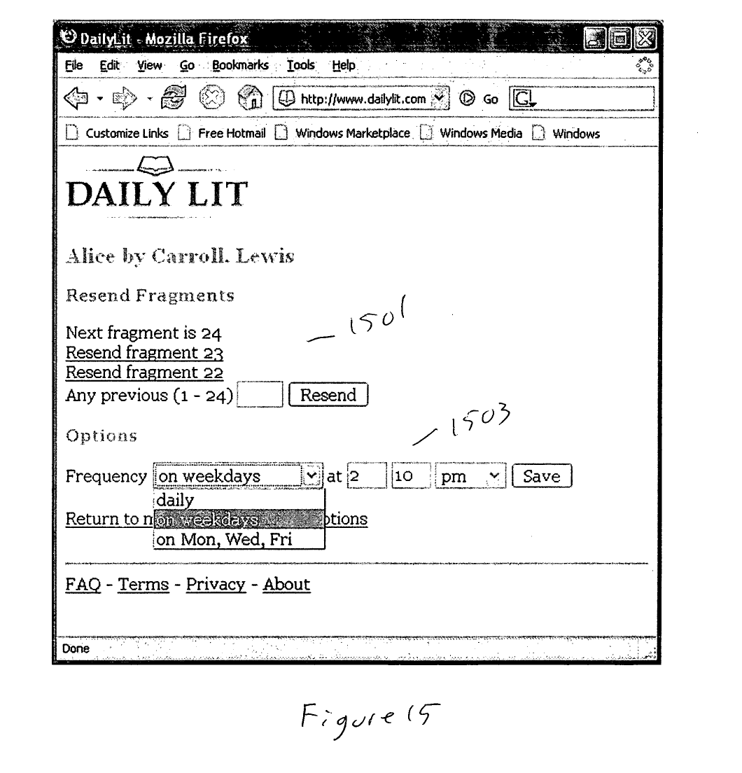

In some embodiments, a recipient may perform more management functions through a specific schedule management interface, such as the one illustrated in FIG. 15. This interface may be reached, in one implementation, by clicking on the link 1403 of FIG. 14. In some implementations, the interface of FIG. 15 may allow a recipient to resend previous portions through a resend interface 1501. Such a feature may allow recipients to receive previous portions of the media that may have been unintentionally skipped by the recipient, not received, or accidentally deleted, for example. In some implementations, the interface of FIG. 15 may allow a recipient to directly view a previous portion through the interface rather than resending an email with the portion. Because email can be unreliable, a feature allowing review or resending of previous portions may be useful in any embodiment of the present invention. A resend feature may be implemented, for example, by searching a database for a requested previously sent portion and transmitting the portion as originally transmitted (e.g., including inserting advertisements, etc. as described above). Similarly, a review function may be implemented by searching the database for the requested previously sent portion, processing the portion, as described above, and displaying a representation of the portion through the user interface (e.g., on the website).

In some implementations, the interface of FIG. 15 may allow a user to alter a time and/or day through a time and/or day interface 1503. In other implementations, such an interface may include options for altering any other parameter of a schedule.

In some embodiments of the present invention, a media system may be configured to distribute portions of a media to advertise the media. Such advertisements methods may allow the recipients the opportunity to freely begin viewing/listening to a media before they decide to purchase and/or schedule transmission of the media. In some embodiments, the media system may, for example, distribute an initial set of preview portion of a media to a recipient. In some implementations, the media system may distribute the portions without first receiving a submitted schedule from the recipient. The media system may choose which such unsolicited media portions to distribute based on stored information regarding the recipient, such as prior media received and demographic information, and information regarding the media, such as genre information and information regarding a target audience. In some implementations, unsolicited portions may be distributed in connection with a release of a new media to advertise the new media. In some implementations such unsolicited transmission may be scheduled at one of a previously scheduled transmission time of the recipient, at some default transmission time, or at a transmission time selected by a distributor of the media.

In some implementations, the unsolicited portions may stop being distributed after an initial set of preview portions has been distributed. In some implementations, a recipient may continue the transmission of the remainder of portion of the media by request such continued transmission. In some implementations a recipient may be required to pay a fee to receive the remaining portions of the media.

In some embodiments of the present invention, a media system may provide forums and reviews related to the media distributed by the system. Such forums and reviews may provide information regarding media of the media system to users of the media system. In some implementations, the forums may allow users to discuss the media by publicly posting and responding to messages regarding the media. In some implementations, the forums may be accessed through one or more interfaces, such as a website. In some implementations, recipient may report their progress through a particular media (e.g., which portion they have received) to the forums. In some implementations, reviews from other recipients and/or professional reviewers may be accessible through one or more interfaces, such as one or more websites.

In some embodiments, users may access recommendations for media based on previously received media. In some implementations, the recommendations may be based on reviews and/or ratings of other recipients that have also received similar media as the recipient receiving the recommendation. Such recommendations may encourage previous recipients of media from the system to schedule transmission of a new media.

In some embodiments, a media system in accordance with the present invention may allow recipient to form media groups. Such groups may allow recipients to share experiences, comments and recommendations regarding media with other recipients. A media group may allow a plurality of recipients to receive portions of the same media according to a substantially similar or an exactly similar schedule. In some implementations, a recipient may start a group through a user interface, such as one or more websites. In some implementations, other recipients may subscribe to a particular group through an interface, such as one or more websites. In some implementations, other recipients may only subscribe to a group after receiving an invitation to subscribe to the group from a member of the group. In some implementations, members of a group may share invitations with other recipients by identifying the other recipients to the media system (e.g., identifying a username or email address) through one or more interfaces, such as one or more websites. In some implementations, a group may be associated with a private forum through which member of the group may discuss the media and recommend media to one another.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the scope of the invention. Accordingly, the foregoing description and drawings are by way of example only.

What is claimed is:

1. A method of distributing at least part of a media, the method comprising acts of:
A) inserting at least one advertisement into at least one of at least one first representation of at least one first portion of the media and at least one second representation of at least one second portion of the media;
B) distributing the at least one first representation at least one first scheduled time; and
C) distributing the at least one second representation at least one second scheduled time.

2. The method of claim 1, further comprising an act of:
D) receiving at least one representation of the at least one advertisement from at least one advertiser.

3. The method of claim 1, wherein the act A includes an act of inserting the at least one advertisement into at least one of the at least one first representation and the at least one second representation based, at least in part, on at least one of an advertising plan of the media and a marketing plan of the at least one advertisement.

4. The method of claim 3, further comprising an act of:
D) adjusting the at least one marketing plan based, at least in part, on an input from at least one advertiser.

5. The method of claim 3, wherein the marketing plan indicating a characteristic of a target market of the at least one advertisement.

6. The method of claim 3, further comprising an act of:
D) adjusting the at least one advertising plan based, at least in part, on an input from a distributor of the media.

7. The method of claim 6, wherein the at least one distributor includes at least one of a publisher of the media and a creator of the media.

8. The method of claim 3, wherein the at least one advertising plan includes at least one of the group comprising:
a plan indicating the at least one advertisement, a plan indicating a type of advertisement to include in the at least one advertisement, a plan indicating a number of advertisements to include in the at least one advertisement, a plan indicating a frequency of advertisements with which to insert the at least one advertisement, and a plan indicating at least one licensing plan.

9. The method of claim 2, wherein the act A includes an act of inserting the at least one advertisement into at least one of the at least one first representation and the at least one second representation based, at least in part, on at least one characteristic of a recipient of at least one of the distributed at least one first representation and distributed at least one second representation.

10. The method of claim 9, wherein the at least one characteristic includes an identity of at least one previously received media.

11. The method of claim 9, wherein the at least one characteristic includes demographic information received from the recipient.

12. The method of claim 11, wherein the demographic information includes at least one of the group comprising:
an age, a gender, a name, an ethnicity, an education, a profession, an income, and a location.

13. The method of claim 9, further comprising an act of D) receiving at least one indication of the at least one characteristic of the recipient.

14. The method of claim 1, wherein the at least one first representation includes at least one preview portion into which the at least one advertisement is not inserted, and wherein the at least one second representation includes at least one subscription portion into which the at least one advertisement is inserted.

15. The method of claim 1, wherein the act B includes at least one of the group comprising:
transmitting at least one email message, transmitting at least one MMS message, and distributing at least one RSS feed.

16. The method of claim 1, wherein the media includes an electronic file comprising at least one of audio, video, image, and textual information.

17. The method of claim 1, wherein the media includes an electronic book.

18. The method of claim 1, further comprising an act of D) dividing at least one representation of the media into the at least one first portion and the at least one second portion.

19. The method of claim 18, wherein the act D includes an act of dividing the at least one representation of the media into the at least one first portion and the at least one second portion based on at least one criterion.

20. The method of claim 19, wherein the at least one criterion includes at least one of the group comprising:
a page break, a length of time, a size of the at least one first representation, a size of the at least one second representation, a chapter break, a scene change, a track break, a character count, a line count, a byte count, a paragraph count, a word count, and a piece of metadata indicating a portion break.

21. The method of claim 19, wherein the at least one criterion includes at least one criterion of at least one advertising plan of at least one of a distributor of the media and an advertiser associated with the at least one advertisement.

22. The method of claim 19, wherein the at least one criterion includes at least one criterion selected by a recipient of the at least one first representation and the at least one second representation.

23. The method of claim 22, further comprising an act of E) receiving at least one indication of a selection of the at least one criterion from the recipient.

24. The method of claim 1, further comprising an act of D) receiving at least one representation of a schedule, wherein the at least one representation of the schedule includes an indication of the at least one first scheduled time and the at least one second scheduled time.

25. The method of claim 24, wherein the at least one representation of the schedule further includes an indication of the media.

26. The method of claim 24, wherein the at least one representation of the schedule further includes an indication of at least one intended recipient of at least one of the at least one first representation and the at least one second representation.

27. The method of claim 26, wherein the at least one intended recipient includes a group of recipients.

28. The method of claim 26, wherein the at least one intended recipient submits the at least one representation of the at least one schedule through at least one user interface.

29. The method of claim 28, wherein the at least one user interface includes at least one website and the at least one representation of the schedule includes at least one HTTP message.

30. The method of claim 1, further comprising an act of D) responding to a request from the recipient of at least one of the at least one first representation and the at least one second representation by distributing at least one third representation of at least one third portion of the media, and wherein the act A includes an act of inserting the at least one advertisement into the at least one third representation.

31. The method of claim 30, wherein the at least one third portion of the media includes at least one of the at least one first portion of the media and the at least one second portion of the media.

32. A method of emailing at least a first portion of a media, the method comprising acts of:
A) inserting at least one advertisement into at least one first representation of at least the first portion of the media; and
B) transmitting at least one first email containing the at least one first representation of at least the first portion of the media.

33. The method of claim 32, further comprising an act of:
C) receiving at least one representation of the at least one advertisement from at least one advertiser.

34. The method of claim 32, wherein the act A includes an act of inserting the at least one advertisement into the at least one first representation based, at least in part, on at least one of an advertising plan of the media and a marketing plan of the at least one advertisement.

35. The method of claim 34, further comprising an act of:
C) adjusting the at least one marketing plan based, at least in part, on an input from at least one advertiser.

36. The method of claim 34, wherein the marketing plan indicating a characteristic of a target market of the at least one advertisement.

37. The method of claim 34, further comprising an act of:
C) adjusting the at least one advertising plan based, at least in part, on an input from at a distributor of the media.

38. The method of claim 37, wherein the at least one distributor includes at least one of a publisher of the media and a creator of the media.

39. The method of claim 34, wherein the at least one advertising plan includes at least one of the group comprising:
a plan indicating the at least one advertisement, a plan indicating a type of advertisement to include in the at least one advertisement, a plan indicating a number of advertisements to include in the at least one advertisement, a plan indicating a frequency of advertisements with which to insert the at least one advertisement, and a plan indicating at least one licensing plan.

40. The method of claim 32, wherein the act A includes an act of inserting the at least one advertisement into the at least one first representation of the at least one first portion of the media based, at least in part, on at least one characteristic of a recipient of the at least one first email.

41. The method of claim 40, wherein the at least one characteristic includes an identity of at least one previously received media.

42. The method of claim 40, wherein the at least one characteristic includes demographic information received from the recipient.

43. The method of claim 42, wherein the demographic information includes at least one of the group comprising:
an age, a gender, a name, an ethnicity, an education, a profession, an income, and a location.

44. The method of claim 40, further comprising an act of C) receiving at least one indication of the at least one characteristic of the recipient.

45. The method of claim 32, wherein the media includes an electronic file comprising at least one of audio, video, image, and textual information.

46. The method of claim 32, wherein the media includes an electronic book.

47. The method of claim 32, further comprising an act of C) transmitting at least one second email containing at least one second representation of at least one second portion of the media.

48. The method of claim 47, wherein the act A further includes an act of inserting the at least one advertisement into the at least one second representation.

49. The method of claim 47, further comprising an act of D) dividing at least one representation of the media into at least the at least one first portion and the at least one second portion.

50. The method of claim 49, wherein the act D includes an act of dividing at least one representation of the media into at least the at least one first portion and the at least one second portion based on at least one criterion.

51. The method of claim 50, wherein the at least one criterion includes at least one of the group comprising:
a page break, a length of time, a size of the at least one first representation, a size of the at least one second representation, a chapter break, a scene change, a track break, a character count, a line count, a byte count, a paragraph count, a word count, and a piece of metadata indicating a portion break.

52. The method of claim 50, wherein the at least one criterion includes at least one criterion of a distributor of the media.

53. The method of claim 50, wherein the at least one criterion includes at least one criterion of a recipient of at least one of the at least one first email and the at least one second email.

54. The method of claim 50, further comprising an act of E) receiving at least one indication of the at least one criterion.

55. The method of claim 47, wherein the act B occurs at a first scheduled time and the act C occurs at a second scheduled time.

56. The method of claim 55, further comprising an act of D) receiving at least one representation of a schedule, wherein the at least one representation of the schedule includes an indication of the at least one first scheduled time and the at least one second scheduled time.

57. The method of claim 56, wherein the at least one representation of the schedule further includes an indication of the media.

58. The method of claim 56, wherein the at least one representation of the schedule further includes an indication of at least one intended recipient of at least one of the at least one first email and the at least one second email.

59. The method of claim 58, wherein the at least one intended recipient includes a group of recipients.

60. The method of claim 58, wherein the at least one intended recipient submits the at least one representation of the schedule through at least one user interface.

61. The method of claim 60, wherein the at least one user interface includes at least one website and the at least one representation of the at least one schedule includes at least one HTTP message.

62. The method of claim 47, further comprising an act of D) responding to a request from the recipient of at least one of the at least one first email and the at least one second email by transmitting at least one third representation of at least one third portion of the media, and wherein the act A includes an act of inserting the at least one advertisement into the at least one third representation of the at least one third portion.

63. The method of claim 62, wherein the third portion includes at least one of the first portion and the second portion.

64. A method of emailing a media, the method comprising acts of:
A) transmitting at least one first email containing at least one first representation of at least one first portion of the media at least one first scheduled time; and
B) transmitting at least one second email containing at least one second representation of at least one second portion of the media at least one second scheduled time, wherein the at least one first portion of the media and the at least one second portion of the media represent the media.

65. The method of claim 64, further comprising an act of C) inserting at least one advertisement into at least one of the at least one first representation and the at least one second representation.

66. The method of claim 65, further comprising an act of:
D) receiving at least one representation of the at least one advertisement from at least one advertiser.

67. The method of claim 65, wherein the act C includes an act of inserting at least one advertisement into at least one of the at least one first representation and the at least one second representation based, at least in part, on at least one of an advertising plan of the media and a marketing plan of the at least one advertisement.

68. The method of claim 67, further comprising an act of:
D) adjusting the at least one marketing plan based, at least in part, on an input from at least one advertiser.

69. The method of claim 67, wherein the marketing plan indicating a characteristic of a target market of the at least one advertisement.

70. The method of claim 67, further comprising an act of:
D) adjusting the at least one advertising plan based, at least in part, on an input from a distributor of the media.

71. The method of claim 70, wherein the at least one distributor includes at least one of a publisher of the media and a creator of the media.

72. The method of claim 67, wherein the at least one advertising plan includes at least one of the group comprising:
a plan indicating the at least one advertisement, a plan indicating a type of advertisement to include in the at least one advertisement, a plan indicating a number of advertisements to include in the at least one advertisement, a plan indicating a frequency of advertisements with which to insert the at least one advertisement, and a plan indicating at least one licensing plan.

73. The method of claim 65, wherein the act C includes an act of inserting the at least one advertisement into at least one of the at least one first representation and at least one second representation based, at least in part, on at least one characteristic of a recipient of at least one of the at least one first email and the at least one second email.

74. The method of claim 73, wherein the at least one characteristic includes an identity of at least one previously received media.

75. The method of claim 73, wherein the at least one characteristic includes demographic information received from the recipient.

76. The method of claim 75, wherein the demographic information includes at least one of the group comprising:
an age, a gender, a name, an ethnicity, an education, a profession, an income, and a location.

77. The method of claim 73, further comprising an act of D) receiving at least one indication of the at least one characteristic of the recipient.

78. The method of claim 65, wherein the at least one first representation includes at least one preview portion into which the at least one advertisement is not inserted, and wherein the at least one second representation of the at least one second portion includes at least one representation of at least one subscription portion into which the at least one advertisement is inserted.

79. The method of claim 64, wherein the media includes an electronic file comprising at least one of audio, video, image, and textual information.

80. The method of claim 64, wherein the media includes an electronic book.

81. The method of claim 64, further comprising an act of C) dividing at least one representation of the media into the at least one first portion of the at least one second portion.

82. The method of claim 81, wherein the act C includes an act of dividing the at least one representation of the media into the at least one first portion of the at least one second portion based on at least one criterion.

83. The method of claim 82, wherein the at least one criterion includes at least one of the group comprising:
a page break, a length of time, a size of the at least one first representation, a size of the at least one second representation, a chapter break, a scene change, a track break, a character count, a line count, a byte count, a paragraph count, a word count, and a piece of metadata indicating a portion break.

84. The method of claim 82, wherein the at least one criterion includes at least one criterion of an advertising plan of a distributor of the media.

85. The method of claim 82, wherein the at least one criterion includes at least one criterion selected by a recipient of at least one of the at least one first email and the at least one second email.

86. The method of claim 85, further comprising an act of D) receiving at least one indication of a selection of the at least one criterion from the recipient.

87. The method of claim 64, further comprising an act of C) receiving at least one representation of a schedule, wherein the at least one representation of the schedule includes at least one indication of the at least one first scheduled time and the at least one second scheduled time.

88. The method of claim 87, wherein the at least one representation of the schedule further includes an indication of the media.

89. The method of claim 87, wherein the at least one representation of the schedule further includes at least one indication of at least one intended recipient of at least one of the at least one first email and the at least one second email.

90. The method of claim 89, wherein the at least one intended recipient includes a group of recipients.

91. The method of claim 89, wherein the at least one intended recipient submits the at least one representation of the schedule through at least one user interface.

92. The method of claim 91, wherein the at least one user interface includes at least one website and the at least one representation of the schedule includes at least one HTTP message.

93. A system for distributing at least part of a media, the system comprising:
an advertising element configured to insert at least one advertisement into at least one of at least one first representation of at least one first portion of the media and at least one second representation of at least one second portion of the media; and
a schedule element configured to distribute the at least one first representation at least one first scheduled time; and configured to distribute the at least one second representation at least one second scheduled time.

94. The system of claim 93, wherein the advertising element is further configured to receive at least one representation of the at least one advertisement from at least one advertiser.

95. The system of claim 93, wherein the advertising element is configured to insert the at least one advertisement into at least one of the at least one first representation and the at least one second representation based, at least in part, on at least one of an advertising plan of the media and a marketing plan of the at least one advertisement.

96. The system of claim 95, wherein the advertising element is further configured to adjust the at least one marketing plan based, at least in part, on an input from at least one advertiser.

97. The system of claim 95, wherein the marketing plan indicating a characteristic of a target market of the at least one advertisement.

98. The system of claim 95, wherein the system further comprises a media element configured to adjust the at least one advertising plan based, at least in part, on an input from at least one of a distributor of the media.

99. The system of claim 98, wherein the at least one distributor includes at least one of a publisher of the media and a creator of the media.

100. The system of claim 95, wherein the at least one advertising plan includes at least one of the group comprising:
a plan indicating the at least one advertisement, a plan indicating a type of advertisement to include in the at least one advertisement, a plan indicating a number of advertisements to include in the at least one advertisement, a plan indicating a frequency of advertisements with which to insert the at least one advertisement, and a plan indicating at least one licensing plan.

101. The system of claim 93, wherein the advertising element is configured to insert the at least one advertisement into at least one of the at least one first representation and the at least one second representation based, at least in part, on at least one characteristic of a recipient of at least one of the distributed at least one first representation and distributed at least one second representation.

102. The system of claim 101, wherein the at least one characteristic includes an identity of at least one previously received media.

103. The system of claim 101, wherein the at least one characteristic includes demographic information received from the recipient.

104. The system of claim 103, wherein the demographic information includes at least one of the group comprising:
an age, a gender, a name, an ethnicity, an education, a profession, an income, and a location.

105. The system of claim 101, wherein the advertising element is further configured to receive at least one indication of the at least one characteristic of the recipient.

106. The system of claim 93, wherein the at least one first representation includes at least one preview portion into which the advertising element is configured not to insert the at least one advertisement, and wherein the at least one second representation includes at least one subscription portion into which the advertising element is configured to insert the at least one advertisement.

107. The system of claim 93, wherein at least one of the first and second representations includes at least one of an email message, an RSS feed, and an MMS message.

108. The system of claim 93, wherein the media includes an electronic file comprising at least one of audio, video, image, and textual information.

109. The system of claim 93, wherein the media includes an electronic book.

110. The system of claim 93, further comprising a media element configured to divide at least one representation of the media into the at least one first portion and the second portion.

111. The system of claim 110, wherein the media element is configured to divide the at least one representation of the media into the at least one first portion and the at least one second portion based on at least one criterion.

112. The system of claim 111, wherein the at least one criterion includes at least one of the group comprising:
a page break, a length of time, a size of the at least one first representation, a size of the at least one second representation, a chapter break, a scene change, a track break, a character count, a line count, a byte count, a paragraph count, a word count, and a piece of metadata indicating a portion break.

113. The system of claim 111, wherein the at least one criterion includes at least one criterion of an advertising plan of at least one of a distributor of the media.

114. The system of claim 111, wherein the at least one criterion includes at least one criterion selected by a recipient of at least one of the distributed at least one first representation and the distributed at least one second representation.

115. The system of claim 114, wherein the media element is further comprising to receive at least one indication of a selection of the at least one criterion from the recipient.

116. The system of claim 93, wherein the schedule element is further configured to receive at least one representation of a schedule, wherein the at least one representation of the schedule includes an indication of the at least one first scheduled time and the at least one second scheduled time.

117. The system of claim 116, wherein the at least one representation of the schedule further includes an indication of the media.

118. The system of claim 116, wherein the at least one representation of the schedule further includes an indication of at least one intended recipient of at least one of the at least one first representation and the at least one second representation.

119. The system of claim 118, wherein the at least one intended recipient includes a group of recipients.

120. The system of claim 93, wherein the schedule element is further configured to respond to a request from the recipient of at least one of the at least one first representation and the at least one second representation by distributing at least one third representation of at least one third portion of the media, and wherein the advertising element is further configured to insert the at least one advertisement into the at least one third representation.

121. A system for emailing at least a first portion of a media, the system comprising:
an advertising element configured to insert at least one advertisement into at least one first representation of at least the first portion of the media; and
a transmission elements configured to transmitting at least one first email containing the at least one first representation of at least the first portion of the media.

122. The system of claim 121, wherein the advertising element is further configured to receive at least one representation of the at least one advertisement from at least one advertiser.

123. The system of claim 121, wherein the advertising element is configured to insert the at least one advertisement into the at least one first representation based, at least in part, on at least one of an advertising plan of the media and a marketing plan of the at least one advertisement.

124. The system of claim 123, wherein the advertising element is further configured to adjust the at least one marketing plan based, at least in part, on an input from at least one advertiser.

125. The system of claim 123, wherein the marketing plan indicating a characteristic of a target market of the at least one advertisement.

126. The system of claim 123, wherein the system further comprises a media element configured to adjust the at least one advertising plan based, at least in part, on an input from at least one of a distributor of the media.

127. The system of claim 126, wherein the at least one distributor includes at least one of a publisher of the media and a creator of the media.

128. The system of claim 123, wherein the at least one advertising plan includes at least one of the group comprising:
a plan indicating the at least one advertisement, a plan indicating a type of advertisement to include in the at least one advertisement, a plan indicating a number of advertisements to include in the at least one advertisement, a plan indicating a frequency of advertisements with which to insert the at least one advertisement, and a plan indicating at least one licensing plan.

129. The system of claim 121, wherein the advertising element is configured to insert the at least one advertisement into the at least one first representation of the at least one first portion of the media based, at least in part, on at least one characteristic of a recipient of the at least one first email.

130. The system of claim 129, wherein the at least one characteristic includes an identity of at least one previously received media.

131. The system of claim 129, wherein the at least one characteristic includes demographic information received from the recipient.

132. The system of claim 131, wherein the demographic information includes at least one of the group comprising:
an age, a gender, a name, an ethnicity, an education, a profession, an income, and a location.

133. The system of claim 129, wherein the advertising element is further configured to receive at least one indication of the at least one characteristic of the recipient.

134. The system of claim 121, wherein the media includes an electronic file comprising at least one of audio, video, image, and textual information.

135. The system of claim 121, wherein the media includes an electronic book.

136. The system of claim 121, wherein the transmission element is further configured to transmit at least one second email containing at least one second representation of at least one second portion of the media.

137. The system of claim 136, wherein the advertising element is further configured to insert the at least one advertisement into the at least one second representation.

138. The system of claim 136, further comprising a media element configured to divide at least one representation of the media into at least the at least one first portion and the at least one second portion.

139. The system of claim 138, wherein the media element is configured to divide the at least one representation of the media into at least the at least one first portion and the at least one second portion based on at least one criterion.

140. The system of claim 139, wherein the at least one criterion includes at least one of the group comprising:
a page break, a length of time, a size of the at least one first representation, a size of the at least one second representation, a chapter break, a scene change, a track break, a character count, a line count, a byte count, a paragraph count, a word count, and a piece of metadata indicating a portion break.

141. The system of claim 139, wherein the at least one criterion includes at least one criterion of a distributor of the media.

142. The system of claim 139, wherein the at least one criterion includes at least one criterion of a recipient of at least one of the at least one first email and the at least one second email.

143. The system of claim 139, wherein the media element is further configured to receive at least one indication of the at least one criterion.

144. The system of claim 136, wherein the transmission element is configured to transmit the at least one first email at a first scheduled time and to transmit the second email at a second scheduled time.

145. The system of claim 144, wherein the transmission element is further configured to receive at least one representation of a schedule, wherein the at least one representation of the schedule includes an indication of the at least one first scheduled time and the at least one second scheduled time.

146. The system of claim 145, wherein the at least one representation of the schedule further includes an indication of the media.

147. The system of claim 145, wherein the at least one representation of the schedule further includes an indication of at least one intended recipient of at least one of the at least one first email and the at least one second email.

148. The system of claim 147, wherein the at least one intended recipient includes a group of recipients.

149. The system of claim 136, wherein the transmission element is further configured to respond to a request from the recipient of at least one of the at least one first email and the at least one second email by transmitting at least one third representation of at least one third portion of the media, and wherein the advertising element is further configured to insert the at least one advertisement into the at least one third representation of the at least one third portion.

150. A system for emailing a media, the system comprising:
a schedule element configured to transmit at least one first email containing at least one first representation of at least one first portion of the media at least one first scheduled time, and configured to transmit at least one second email containing at least one second representation of at least one second portion of the media at least one second scheduled time, wherein the at least one first portion of the media and the at least one second portion of the media represent the media.

151. The system of claim 150, further comprising an advertising element configured to insert at least one advertisement into at least one of the at least one first representation and the at least one second representation.

152. The system of claim 151, wherein the advertising element is further configured to receive at least one representation of the at least one advertisement from at least one advertiser.

153. The system of claim 151, wherein the advertising element is configured to insert the at least one advertisement into at least one of the at least one first representation and the at least one second representation based, at least in part, on at least one of an advertising plan of the media and a marketing plan of the at least one advertisement.

154. The system of claim 153, wherein the advertising element is further configured to adjust the at least one marketing plan based, at least in part, on an input from at least one advertiser.

155. The system of claim 153, wherein the marketing plan indicating a characteristic of a target market of the at least one advertisement.

156. The system of claim 153, wherein the system further comprises a media element configured to adjust the at least one advertising plan based, at least in part, on an input from at least one of a distributor of the media.

157. The system of claim 156, wherein the at least one distributor includes at least one of a publisher of the media and a creator of the media.

158. The system of claim 153, wherein the at least one advertising plan includes at least one of the group comprising:
a plan indicating the at least one advertisement, a plan indicating a type of advertisement to include in the at least one advertisement, a plan indicating a number of advertisements to include in the at least one advertisement, a plan indicating a frequency of advertisements with which to insert the at least one advertisement, and a plan indicating at least one licensing plan.

159. The system of claim 151, wherein the advertising element is configured to insert the at least one advertisement into at least one of the at least one first representation and at least one second representation based, at least in part, on at least one characteristic of a recipient of at least one of the at least one first email and the at least one second email.

160. The system of claim 159, wherein the at least one characteristic includes an identity of at least one previously received media.

161. The system of claim 159, wherein the at least one characteristic includes demographic information received from the recipient.

162. The system of claim 161, wherein the demographic information includes at least one of the group comprising:
an age, a gender, a name, an ethnicity, an education, a profession, an income, and a location.

163. The system of claim 159, wherein the advertising element is further configured to receive at least one indication of the at least one characteristic of the recipient.

164. The system of claim 151, wherein the at least one first representation includes at least one preview portion into which the advertisement element is configured not to insert the at least one advertisement, and wherein the at least one second representation of the at least one second portion includes at least one representation of at least one subscription portion into which the advertisement element is configured to insert the least one advertisement.

165. The system of claim 150, wherein the media includes an electronic file comprising at least one of audio, video, image, and textual information.

166. The system of claim 150, wherein the media includes an electronic book.

167. The system of claim 150, further comprising a media element configured to divide at least one representation of the media into the at least one first portion and at least one second portion.

168. The system of claim 167, wherein the media element is configured to divide the at least one representation of the media into the at least one first portion and the at least one second portion based on at least one criterion.

169. The system of claim 168, wherein the at least one criterion includes at least one of the group comprising:
a page break, a length of time, a size of the at least one first representation, a size of the at least one second representation, a chapter break, a scene change, a track break, a character count, a line count, a byte count, a paragraph count, a word count, and a piece of metadata indicating a portion break.

170. The system of claim 168, wherein the at least one criterion includes at least one criterion of an advertising plan of a distributor of the media.

171. The system of claim 168, wherein the at least one criterion includes at least one criterion selected by a recipient of at least one of the at least one first email and the at least one second email.

172. The system of claim 171, further wherein the media element is further configured to receive at least one indication of a selection of the at least one criterion from the recipient.

173. The system of claim 150, wherein the schedule element is further configured to receive at least one representation of a schedule, wherein the at least one representation of the schedule includes at least one indication of the at least one first scheduled time and the at least one second scheduled time.

174. The system of claim 173, wherein the at least one representation of the schedule further includes an indication of the media.

175. The system of claim 173, wherein the at least one representation of the schedule further includes at least one indication of at least one intended recipient of at least one of the at least one first email and the at least one second email.

176. The system of claim 175, wherein the at least one intended recipient includes a group of recipients.

177. A method of distributing at least part of a media, the method comprising acts of:
A) distributing at least one first representation of a preview portion of the media to at least one recipient at least one first scheduled time;
B) receiving a media subscription fee from the at least one recipient; and
C) after receiving the media subscription fee, distributing at least one second representation of a subscription portion of the media at least one second scheduled time.

178. The method of claim 177, further comprising an act of D) inserting at least one advertisement into at least one of the at least one first representation and the at least one second representation.

179. The method of claim 178, further comprising an act of:
D) receiving at least one representation of the at least one advertisement from at least one advertiser.

180. The method of claim 178, wherein the act D includes an act of inserting the at least one advertisement into at least one of the at least one first representation and the at least one second representation based, at least in part, on at least one of an advertising plan of the media and a marketing plan of the at least one advertisement.

181. The method of claim 180, wherein the at least one advertising plan includes at least one of the group comprising:
a plan indicating the at least one advertisement, a plan indicating a type of advertisement to include in the at least one advertisement, a plan indicating a number of advertisements to include in the at least one advertisement, a plan indicating a frequency of advertisements with which to insert the at least one advertisement, and a plan indicating at least one licensing plan.

182. The method of claim 177, wherein the media includes an electronic file comprising at least one of audio, video, image, and textual information.

183. The method of claim 177, wherein the media includes an electronic book.

184. The method of claim 177, further comprising an act of D) dividing at least one representation of the media into the at least one first portion and the at least one second portion.

185. The method of claim 184, wherein the act D includes an act of dividing the at least one representation of the media into the at least one first portion and the at least one second portion based on at least one criterion.

186. The method of claim 185, wherein the at least one criterion includes at least one of the group comprising:
a page break, a length of time, a size of the at least one first representation, a size of the at least one second representation, a chapter break, a scene change, a track break, a character count, a line count, a byte count, a paragraph count, a word count, and a piece of metadata indicating a portion break.

187. The method of claim 185, wherein the at least one criterion includes at least one criterion of an advertising plan of a distributor of the media.

188. The method of claim 185, wherein the at least one criterion includes at least one criterion selected by a recipient of at least one of the at least one first email and the at least one second email.

189. The method of claim 188, further comprising an act of E) receiving at least one indication of a selection of the at least one criterion from the recipient.

190. The method of claim 177, further comprising an act of D) receiving at least one representation of a schedule, wherein the at least one representation of the schedule includes at least one indication of the at least one first scheduled time and the at least one second scheduled time.

191. The method of claim 190, wherein the at least one representation of the schedule further includes an indication of the media.

192. The method of claim 190, wherein the at least one representation of the schedule further includes at least one indication of at least one intended recipient of at least one of the at least one first email and the at least one second email.

193. The method of claim 192, wherein the at least one intended recipient includes a group of recipients.

194. The method of claim 192, wherein the at least one intended recipient submits the at least one representation of the schedule through at least one user interface.

195. The method of claim 194, wherein the at least one user interface includes at least one website and the at least one representation of the schedule includes at least one HTTP message.

196. A system for distributing at least part of a media, the system comprising:
a subscription element configured to receive a media subscription fee from at least one recipient; and
a schedule element configured to distribute at least one representation of a preview portion of the media to at least one recipient at least one first scheduled time, and configured to distribute at least one representation of a subscription portion of the media at least one second scheduled time only after the subscription element receives the media subscription fee.

197. The system of claim 196, further comprising an advertising element configured to insert at least one advertisement into at least one of the at least one first representation and the at least one second representation.

198. The system of claim 197, wherein the advertising element is further configured to receive at least one representation of the at least one advertisement from at least one advertiser.

199. The system of claim 197, wherein the advertising element is configured to insert the at least one advertisement into at least one of the at least one first representation and the at least one second representation based, at least in part, on at least one of an advertising plan of the media and a marketing plan of the at least one advertisement.

200. The system of claim 199, wherein the at least one advertising plan includes at least one of the group comprising:
a plan indicating the at least one advertisement, a plan indicating a type of advertisement to include in the at least one advertisement, a plan indicating a number of advertisements to include in the at least one advertisement, a plan indicating a frequency of advertisements with which to insert the at least one advertisement, and a plan indicating at least one licensing plan.

201. The system of claim 196, wherein the media includes an electronic file comprising at least one of audio, video, image, and textual information.

202. The system of claim 196, wherein the media includes an electronic book.

203. The system of claim 196, further comprising a media element configured to divide at least one representation of the media into the at least one first portion and the at least one second portion.

204. The system of claim 203, wherein the media element is configured to divide at least one representation of the media into the at least one first portion and the at least one second portion based on at least one criterion.

205. The system of claim 204, wherein the at least one criterion includes at least one of the group comprising:
a page break, a length of time, a size of the at least one first representation, a size of the at least one second representation, a chapter break, a scene change, a track break, a character count, a line count, a byte count, a paragraph count, a word count, and a piece of metadata indicating a portion break.

206. The system of claim 204, wherein the at least one criterion includes at least one criterion of an advertising plan of a distributor of the media.

207. The system of claim 204, wherein the at least one criterion includes at least one criterion selected by a recipient of at least one of the at least one first email and the at least one second email.

208. The system of claim 207, wherein the media element is further configured to receive at least one indication of a selection of the at least one criterion from the recipient.

209. The system of claim 196, wherein the schedule element is further configured to receive at least one representation of a schedule, wherein the at least one representation of the schedule includes at least one indication of the at least one first scheduled time and the at least one second scheduled time.

210. The system of claim 209, wherein the at least one representation of the schedule further includes an indication of the media.

211. The system of claim 209, wherein the at least one representation of the schedule further includes at least one indication of at least one intended recipient of at least one of the at least one first email and the at least one second email.

212. The system of claim 211, wherein the at least one intended recipient includes a group of recipients.

213. The system of claim 211, wherein the at least one intended recipient submits the at least one representation of the schedule through at least one user interface.

214. The system of claim 213, wherein the at least one user interface includes at least one website and the at least one representation of the schedule includes at least one HTTP message.

215. A method of distributing at least part of a media, the method comprising acts of:
A) receiving an indication of an email address from a user;
B) receiving an indication of the media from the user;
C) receiving an indication of a schedule from the user; and
D) without requiring the user to provide registration information, transmitting at least one first email representing at least a first portion of the media to the user at a time and day based, at least in part, on the schedule.

216. The method of claim 215, further comprising:
E) transmitting at least one second email representing at least a second portion of the media at a time and day based, at least in part, on the schedule,
wherein the at least the first portion and the at least the second portion represent the media.

217. The method of claim 215, further comprising:
E) inserting at least one advertisement into the at least one first email before transmitting the at least one first email to the user.

218. The method of claim 217, further comprising an act of:
F) receiving at least one representation of the at least one advertisement from at least one advertiser.

219. The method of claim 217, wherein the act E includes an act of inserting the at least one advertisement into the at least one first email based, at least in part, on at least one of an advertising plan of the media and a marketing plan of the at least one advertisement.

220. The method of claim 219, further comprising an act of:
F) adjusting the at least one marketing plan based, at least in part, on an input from at least one advertiser.

221. The method of claim 219, wherein the marketing plan indicating a characteristic of a target market of the at least one advertisement.

222. The method of claim 219, further comprising an act of:
F) adjusting the at least one advertising plan based, at least in part, on an input from a distributor of the media.

223. The method of claim 222, wherein the at least one distributor includes at least one of a publisher of the media and a creator of the media.

224. The method of claim 219, wherein the at least one advertising plan includes at least one of the group comprising:
a plan indicating the at least one advertisement, a plan indicating a type of advertisement to include in the at least one advertisement, a plan indicating a number of advertisements to include in the at least one advertisement, a plan indicating a frequency of advertisements with which to insert the at least one advertisement, and a plan indicating at least one licensing plan.

225. The method of claim 217, wherein the act E includes an act of inserting the at least one advertisement based, at least in part, on at least one characteristic of the user.

226. The method of claim 225, wherein the at least one characteristic includes an identity of at least one previously received media.

227. The method of claim 226, wherein the at least one characteristic includes demographic information received from the user.

228. The method of claim 227, wherein the demographic information includes at least one of the group comprising:
an age, a gender, a name, an ethnicity, an education, a profession, an income, and a location.

229. The method of claim 226, further comprising an act of F) receiving at least one indication of the at least one characteristic of the user.

230. The method of claim 215, wherein the media includes an electronic file comprising at least one of audio, video, image, and textual information.

231. The method of claim 215, wherein the media includes an electronic book.

232. The method of claim 215, further comprising an act of E) dividing at least one representation of the media into the at least one first portion of the media

233. The method of claim 232, wherein the act E includes an act of dividing the at least one representation of the media based on at least one criterion.

234. The method of claim 233, further comprising an act of F) receiving at least one indication of the at least one criterion from the recipient.

235. The method of claim 215, wherein the first email includes at least one hyperlink to at least one management interface.

236. The method of claim 235, wherein the at least one management interface includes at least one website through which the user may manage transmission of the media.

237. The method of claim 235, further comprising acts of:
E) receiving at least one request to adjust the schedule from the user; and
F) adjusting the schedule based, at least in part, on the at least one request.

238. The method of claim 235, further comprising acts of:
E) receiving at least one request to review at least one previously transmitted portion of the media from the user.

239. The method of claim 238, further comprising an act of:
F) transmitting a second email representing the at least one previously transmitted portion of the media to the user

240. The method of claim 238, further comprising an act of:
F) displaying the at least one previously transmitted portion of the media to the user through the management interface.

241. The method of claim 215 further comprising an act of:
E) providing the user with a subscription management interface.

242. The method of claim 241, wherein the user may manage the schedule and a plurality of other schedules associated with the user through the subscription management interface.

243. A method of distributing portions of media, the method comprising acts of:
A) distributing a first plurality of portions of a first version of the media to a first user according to a first schedule; and
B) distributing a second plurality of portions of a second version of the media to a second user according to a second schedule.

244. The method of claim 243, wherein distributing the first plurality of portions includes transmitting a plurality of first emails to the first user, and distributing the second plurality of portions includes transmitting a plurality of second emails to the second user.

245. The method of claim 243, wherein the first version of the media includes a first set of portion breaks, and the second version of the media includes a second set of portion breaks, each portion break corresponding to an end of a respective portion.

246. The method of claim 245, wherein the first set of portion breaks are determined based on at least one of a first page break, a first length of time, a first portion size, a first chapter break, a first scene change, a first track break, a first character count, a first line count, a first byte count, a first word count, a first paragraph count, and a first piece of metadata, and the second set of portion breaks are determined based on at least one of a second page break, a second length of time, a second portion size, a second chapter break, a second scene change, a second track break, a second character count, a second line count, a second byte count, a second word count, a second paragraph count, and a second piece of metadata.

247. The method of claim 243, further comprising acts of:
C) dividing the media into the first plurality of portions based, at least in part on a first criterion, and
D) dividing the media into the second plurality of portions based, at least in part, on a second criterion.

248. The method of claim 247, further comprising acts of:
E) receiving a representation of the first criterion from at least one of the first user and a distributor of the media; and
F) receiving a representation of the second criterion from at least one of the second user and the distributor of the media.

249. The method of claim 243, wherein the first version of the media includes a first set of content and the second version of the media includes a second set of content.

250. The method of claim 249, further comprising acts of:
C) receiving a representation of a selection of the first version from the first user; and
D) receiving a representation of a selection of the second version from the second user.

251. The method of claim 249, further comprising an act of receiving the first and second version of the media from a distributor of the media.

252. The method of claim 243, further comprising acts of:
C) receiving a representation of a first subscription to the media from the first user; and
D) receiving a representation of a second subscription to the media from the second user.

253. The method of claim 252, wherein the first subscription includes the first schedule and the second subscription includes the second schedule.

254. The method of claim 252, further comprising an act of E) assigning the first version of the media to the first user based, at least in part, on a first time at which the representation of the first schedule is received, and the assigning the second version of the media to the second user based at least in part on a second time at which the representation of the second schedule is received.

255. The method of claim 254, further comprising an act of E) receiving a representation of the second version of the media.

256. The method of claim 255, wherein the first time is before the act E and the second time is after the act E.

257. The method of claim 255, wherein the representation of the second version of the media is received from a distributor of the media.

258. The method of claim 243, wherein the media includes an electronic file comprising at least one of audio, video, image, and textual information

259. The method of claim 243, wherein the media includes an electronic book.

260. The method of claim 243, further comprising acts of:
C) inserting at least one first advertisement into the first plurality of portions; and
D) inserting at least one second advertisement into the second plurality of portions.

261. A system for distributing at least part of a media, the system comprising:
a subscription element configured to receive an indication of an email address from a user, receive an indication of the media from the user, and receive an indication of a schedule from the user; and
a schedule element configured to transmit at least one first email representing at least a first portion of the media to the user at a time and day based, at least in part, on the schedule without requiring the user to provide registration information.

262. The system of claim 261, wherein the schedule element is configured to transmit at least one second email representing at least a second portion of the media at a time and day based, at least in part, on the schedule, wherein the at least the first portion and the at least the second portion represent the media.

263. The system of claim 261, further comprising an advertising element configured to insert at least one advertisement into the at least one first email before the schedule element transmits the at least one first email to the user.

264. The system of claim 263, wherein the advertising element is configured to receive at least one representation of the at least one advertisement from at least one advertiser.

265. The system of claim 263, wherein the advertising element is configured to insert the at least one advertisement into the at least one first email based, at least in part, on at least one of an advertising plan of the media and a marketing plan of the at least one advertisement.

266. The system of claim 265, wherein the advertising element is configured to adjust the at least one marketing plan based, at least in part, on an input from at least one advertiser.

267. The system of claim 265, wherein the marketing plan indicating a characteristic of a target market of the at least one advertisement.

268. The system of claim 265, wherein the advertising element is configured to adjust the at least one advertising plan based, at least in part, on an input from a distributor of the media.

269. The system of claim 268, wherein the at least one distributor includes at least one of a publisher of the media and a creator of the media.

270. The system of claim 265, wherein the at least one advertising plan includes at least one of the group comprising:
a plan indicating the at least one advertisement, a plan indicating a type of advertisement to include in the at least one advertisement, a plan indicating a number of advertisements to include in the at least one advertisement, a plan indicating a frequency of advertisements with which to insert the at least one advertisement, and a plan indicating at least one licensing plan.

271. The system of claim 263, wherein the advertising element is configured to insert the at least one advertisement based, at least in part, on at least one characteristic of the user.

272. The system of claim 271, wherein the at least one characteristic includes an identity of at least one previously received media.

273. The system of claim 272, wherein the at least one characteristic includes demographic information received from the user.

274. The system of claim 273, wherein the demographic information includes at least one of the group comprising:
an age, a gender, a name, an ethnicity, an education, a profession, an income, and a location.

275. The system of claim 272, wherein the advertising element is configured to receive at least one indication of the at least one characteristic.

276. The system of claim 261, wherein the media includes an electronic file comprising at least one of audio, video, image, and textual information.

277. The system of claim 261, wherein the media includes an electronic book.

278. The system of claim 261, further comprising a media element configured to divide at least one representation of the media into the at least one first portion of the media

279. The system of claim 278, wherein the media element is configured to divide the at least one representation of the media based on at least one criterion.

280. The system of claim 279, wherein the media element is configured to receive at least one indication of the at least one criterion from the user.

281. The system of claim 261, wherein the first email includes at least one hyperlink to at least one management interface.

282. The system of claim 281, wherein the at least one management interface includes at least one website through which the user may manage transmission of the media, and further comprising at least one management element configured to provide the management interface in response to the user clicking on the at least on hyperlink.

283. The system of claim 281, wherein the management element is configured to receiving at least one request to adjust the schedule from the user; and the schedule element is configured to adjust the schedule based, at least in part, on the at least one request.

284. The system of claim 282, wherein the management element is configured to receive at least one request to review at least one previously transmitted portion of the media from the user.

285. The system of claim 284, wherein the management element is configured to transmit a second email representing the at least one previously transmitted portion of the media to the user

286. The system of claim 284, wherein the management element is configured to display the at least one previously transmitted portion of the media to the user through the management interface.

287. The apparatus of claim 261 further comprising at least one management element configured to provide the user with a subscription management interface.

288. The apparatus of claim 287, wherein the user may manage the schedule and a plurality of other schedules associated with the user through the subscription management interface.

289. A system for distributing portions of media, the system comprising:
a schedule element configured to distribute a first plurality of portions of a first version of the media to a first user according to a first schedule, and configured to distribute a second plurality of portions of a second version of the media to a second user according to a second schedule; and
a media element configured to store at least one representation of the media.

290. The system of claim 289, wherein the schedule element is configured to transmit a plurality of first emails to the first user, and transmit a plurality of second emails to the second user.

291. The system of claim 289, wherein the first version of the media includes a first set of portion breaks, and the second version of the media includes a second set of portion breaks, each portion break corresponding to an end of a respective portion.

292. The system of claim 291, wherein the media element is configured to determined the first set of portion breaks based on at least one of a first page break, a first length of time, a first portion size, a first chapter break, a first scene change, a first track break, a first character count, a first line count, a first byte count, a first word count, a first paragraph count, and a first piece of metadata, and the to determine the second set of portion breaks based on at least one of a second page break, a second length of time, a second portion size, a second chapter break, a second scene change, a second track break, a second character count, a second line count, a second byte count, a second word count, a second paragraph count, and a second piece of metadata.

293. The system of claim 289, wherein the media element is configured to divide the media into the first plurality of portions based, at least in part on a first criterion, and to divide the media into the second plurality of portions based, at least in part, on a second criterion.

294. The system of claim 293, wherein the media element is configured to receiving a representation of the first criterion from at least one of the first user and a distributor of the media, and to receive a representation of the second criterion from at least one of the second user and the distributor of the media.

295. The system of claim 289, wherein the first version of the media includes a first set of content and the second version of the media includes a second set of content.

296. The system of claim 295, wherein the media element is configured to receive a representation of a selection of the first version from the first user, and to receive a representation of a selection of the second version from the second user.

297. The system of claim 295, wherein the media element is configured to receive the first and second version of the media from a distributor of the media.

298. The system of claim 289, wherein the schedule element is configured to receive a representation of a first subscription to the media from the first user, and to receive a representation of a second subscription to the media from the second user.

299. The system of claim 298, wherein the first subscription includes the first schedule and the second subscription includes the second schedule.

300. The system of claim 298, wherein the media element is configured to assign the first version of the media to the first user based, at least in part, on a first time at which the representation of the first schedule is received, and the to assign the second version of the media to the second user based at least in part on a second time at which the representation of the second schedule is received.

301. The system of claim 300, wherein the media element is configured to receive a representation of the second version of the media.

302. The system of claim 301, wherein the first time is before the act E and the second time is after the act E.

303. The system of claim 301, wherein the media element is configured to receive the representation of the second version of the media from a distributor of the media.

304. The system of claim 289, wherein the media includes an electronic file comprising at least one of audio, video, image, and textual information

305. The system of claim 289, wherein the media includes an electronic book.

306. The system of claim 289, further comprising an advertising element configured to insert at least one first advertisement into the first plurality of portions, and to insert at least one second advertisement into the second plurality of portions.
